(19) United States
(12) Patent Application Publication
(10) Pub. No.: US 2025/0193051 A1
(43) Pub. Date: Jun. 12, 2025

(54) METHOD PERFORMED BY NETWORK NODE AND NETWORK NODE

(71) Applicant: Samsung Electronics Co., Ltd., Suwon-si (KR)

(72) Inventors: Rongrong LI, Beijing (CN); Dong WANG, Beijing (CN); Yuqing WANG, Beijing (CN); Chunhua WANG, Beijing (CN)

(21) Appl. No.: 18/962,526

(22) Filed: Nov. 27, 2024

Related U.S. Application Data
(63) Continuation of application No. PCT/KR2024/017203, filed on Nov. 4, 2024.

(30) Foreign Application Priority Data
Dec. 6, 2023 (CN) 202311667052.X

(51) Int. Cl. H04L 25/02

(52) U.S. Cl. CPC H04L 25/0224

(57) ABSTRACT

A method performed by a network node is provided. The method includes obtaining a first channel estimation value of a channel between the network node and a user equipment, by performing frequency-domain channel estimation based on a decorrelation signal related to reference signal symbols received from the user equipment, determining whether a channel type of the channel is a high-speed train channel, and in accordance with a determination that the channel type of the channel is the high-speed train channel adjusting frequency offset of the channel, and obtaining a second channel estimation value based on the adjusted frequency offset and the first channel estimation value.

### CROSS-REFERENCE TO RELATED APPLICATION(S)

This application is a continuation application, claiming priority under § 365 (c), of an International application No. PCT/KR2024/017203, filed on Nov. 4, 2024, which is based on and claims the benefit of a Chinese patent application number 202311667052.X, filed on Dec. 6, 2023, in the Chinese Intellectual Property Office, the disclosure of which is incorporated by reference herein in its entirety.

### TECHNICAL FIELD

The disclosure relates to a field of a mobile communication technology. More particularly, the disclosure relates to a method and a network node for channel estimation of a high speed train (HST) cell in a virtual radio access network (vRAN) system.

### BACKGROUND ART

The coverage and quality of high-speed train communication, which is a scenario that must be supported by current communication products, is an important challenge for the current communication products. Accurate channel estimation is the key to ensure the performance of high-speed train scenario. Accurate frequency offset estimation is a great challenge for channel estimation of high-speed train scenario due to the particularity of high-speed train channel.

Existing channel estimation methods are unable to accurately estimate the frequency offset range of high-speed train channel, and an erroneous frequency offset can lead to reduced capacity of a cell, a high failure rate of user access, and poor user experience.

How to accurately estimate the frequency offset for the high-speed train channel, and perform better channel estimation to meet the communication requirements, is a technical problem that technicians in this field have been trying to study.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by a network node and the network node.

Additional aspects will be set forth in part in the description which follows and, in part, will be apparent from the description, or may be learned by practice of the presented embodiments.

In accordance with an aspect of the disclosure, a method performed by a first network node is provided. The method includes obtaining a first channel estimation value of a channel used by a user equipment, by performing frequency-domain channel estimation based on demodulation reference signal (DMRS) symbol decorrelation signal received from the user equipment, determining a channel type of the channel, and adjusting frequency offset of the channel and obtaining a second channel estimation value based on the adjusted frequency offset and the first channel estimation value, when the channel type of the channel is a high-speed train channel.

Alternatively, the obtaining the first channel estimation value of the channel used by the user equipment, by performing the frequency-domain channel estimation based on demodulation reference signal (DMRS) symbol decorrelation signal received from the user equipment includes obtaining a time offset regarding the channel, by performing time offset estimation based on the decorrelation signal, and obtaining the first channel estimation value, by performing time offset compensation on the decorrelation signal based on the time offset.

Alternatively, the determining the channel type of the channel comprises determining the channel type of the channel through a neural network, based on the decorrelation signal.

Alternatively, the neural network is one of a support vector machine, a convolutional neural network, a recurrent neural network, long short-term memory, a transformer network, a multilayer perceptron mixer.

Alternatively, the determining the channel type of the channel through the neural network, based on the decorrelation signal, comprises obtaining at least one feature of a phase feature, an amplitude feature, a path number feature of the channel, and a signal to noise ratio of the channel, according to the decorrelation signal, determining the channel type of the channel through the neural network, based on the at least one feature.

Alternatively, the obtaining the at least one feature of the phase feature, the amplitude feature, the path number feature of the channel, and the signal to noise ratio of the channel, according to the decorrelation signal, comprises determining the Signal to Noise Ratio of the channel according to the decorrelation signal, and/or obtaining a first signal matching a frequency-domain resource dimension of the neural network by matching a dimension of the decorrelation signal with the frequency-domain resource dimension of the neural network, and extracting at least one of the phase feature and the amplitude feature of the first signal on each resource element and the path number feature of the channel, according to the first signal.

Alternatively, the determining the channel type of the channel through the neural network, based on the at least one feature comprises determining the channel type of the channel through the neural network according to the at least one feature and the first signal.

Alternatively, the obtaining the first signal matching the frequency-domain resource dimension of the neural network by matching the dimension of the decorrelation signal with the frequency-domain resource dimension of the neural network, comprises if the dimension of the decorrelation signal is equal to the frequency-domain resource dimension of the neural network, determining the decorrelation signal as the first signal, if the dimension of the decorrelation signal is less than the frequency-domain resource dimension of the neural network, obtaining the first signal, by extending the dimension of the decorrelation signal to the frequency-domain resource dimension of the neural network based on the time offset regarding the channel, if the dimension of the decorrelation signal is greater than the frequency-domain resource dimension of the neural network, intercepting a portion from the decorrelation signal, based on the frequency-domain resource dimension of the neural network, as the first signal.

Alternatively, the extracting the path number feature of the channel, according to the first signal, comprises determining an amplitude of a time-domain pulse response of the channel according to the first signal, extracting the path number feature of the channel according to the count of the amplitudes of the time-domain pulse response that exceeds a predetermined threshold.

Alternatively, the adjusting the frequency offset of the channel involves determining frequency offset regions that require adjustment in the frequency offset and performing frequency offset adjustment in the frequency offset regions.

Alternatively, the determining the frequency offset regions that require adjustment in the frequency offset comprises determining the frequency offset regions that require adjustment in the frequency offset by performing edge detection on the frequency offset.

Alternatively, the determining the frequency offset regions that require adjustment in the frequency offset further involves performing filtering and/or moving averaging on the frequency offset prior to the edge detection.

Alternatively, the determining the frequency offset regions that require adjustment in the frequency offset by performing the edge detection on the frequency offset comprises calculating slopes of the frequency offset, determining positive jumping edges and negative jumping edges of the frequency offset according to the slopes of the frequency offset, determining frequency offset between a positive jumping edge and a negative jumping edge which are adjacent as the frequency offset regions requiring adjustment.

Alternatively, the performing the frequency offset adjustment on the frequency offset regions comprises decreasing frequency offset that is positive in the frequency offset regions by a first predetermined value, and/or increasing frequency offset that is negative in the frequency offset regions by a first predetermined value.

In accordance with another aspect of the disclosure, a network node is provided. The network node includes a transceiver configured to transmit and receive a signal, and a processor coupled to the transceiver and configured to obtain a first channel estimation value of a channel used by a user equipment, by performing frequency-domain channel estimation based on demodulation reference signal (DMRS) symbol decorrelation signal received from the user equipment, determine a channel type of the channel, and adjust frequency offset of the channel and obtaining a second channel estimation value based on the adjusted frequency offset and the first channel estimation value, when the channel type of the channel is a high-speed train channel.

In accordance with another aspect of the disclosure, one or more non-transitory computer-readable storage media storing computer-executable instructions that, when executed by one or more processors individually or collectively, cause an electronic device to perform operations are provided. The operations include obtaining a first channel estimation value of a channel used by a user equipment, by performing frequency-domain channel estimation based on demodulation reference signal (DMRS) symbol decorrelation signal received from the user equipment, determining a channel type of the channel, and adjusting frequency offset of the channel and obtaining a second channel estimation value based on the adjusted frequency offset and the first channel estimation value, when the channel type of the channel is a high-speed train channel.

The beneficial effects brought by the technical solutions provided by the embodiments of the disclosure will be described in the later section in combination with specific optional embodiments, or may be learned from descriptions of the embodiments, or may be learned from implementation of the embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating locations of demodulation reference signal (DMRS) symbols according to an embodiment of the disclosure;

FIG. 2 is a schematic diagram illustrating a high speed train (HST) cell according to an embodiment of the disclosure;

FIG. 3 is a schematic diagram illustrating a doppler frequency offset (FO) curve of a typical high-speed train channel according to an embodiment of the disclosure;

FIG. 4 is a schematic diagram illustrating a frequency offset curve estimated based on DMRS symbol according to an embodiment of the disclosure;

FIG. 5 is a schematic diagram illustrating a doppler frequency offset curve of a non-high-speed train channel (i.e., a normal channel) according to an embodiment of the disclosure;

FIG. 6A is a flowchart illustrating a method performed by a network node according to an embodiment of the disclosure;

FIG. 6B is a schematic diagram illustrating a channel estimation process according to an embodiment of the disclosure;

FIG. 7A is a flowchart illustrating a process for determining a channel type of a channel through a neural network based on a decorrelation signal according to an embodiment of the disclosure;

FIG. 7B is a schematic diagram illustrating a feature extraction process according to an embodiment of the disclosure;

FIGS. 8A and 8B are schematic diagrams illustrating a frequency-domain adaptation process according to an embodiment of the disclosure;

FIGS. 9A and 9B are diagrams illustrating time-domain pulse responses and characteristics of a high-speed train channel and a non-high-speed train channel according to an embodiment of the disclosure;

FIG. 10 is a schematic diagram illustrating a channel type determiner based on a support vector machine according to an embodiment of the disclosure;

FIG. 11A is a flowchart illustrating a process for adjusting frequency offset according to an embodiment of the disclosure;

FIG. 11B is a schematic diagram illustrating a process for adjusting (i.e., adaptively adjusting) frequency offset according to an embodiment of the disclosure;

FIG. 12 is a schematic diagram illustrating an estimated frequency offset curve at a high-speed train channel according to an embodiment of the disclosure;

FIGS. 13A and 13B are schematic diagrams illustrating a frequency offset curve, in which noise is suppressed, according to an embodiment of the disclosure;

FIG. 14 is a schematic diagram illustrating a slope curve of a frequency offset curve according to an embodiment of the disclosure;

FIG. 15 is a schematic diagram illustrating a Marker curve according to an embodiment of the disclosure;

FIG. 16 is a schematic diagram illustrating the division of a frequency offset curve according to an embodiment of the disclosure;

FIG. 17 is a schematic diagram illustrating a process, result, and comparison of adaptive adjustment of a frequency offset curve according to an embodiment of the disclosure;

FIG. 18 is a diagram illustrating a system in which a method performed by a network node according to an embodiment of the disclosure;

FIG. 19 is a block diagram illustrating a network node according to an embodiment of the disclosure; and

FIG. 20 illustrates a schematic diagram of a structure of an electronic equipment applicable according to an embodiment of the disclosure.

Throughout the drawings, it should be noted that like reference numbers are used to depict the same or similar elements, features, and structures.

### DETAILED DESCRIPTION OF THE EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known features and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an” and “the” include plural reference unless the context clearly dictates otherwise. Thus, for example, reference to “a component surface” includes reference to one or more such surfaces.

When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the disclosure, and does not limit the presence of one or more additional functions, operations, or features. In addition, the terms “include” or “have” may be interpreted to denote certain features, figures, steps, operations, constituent elements, components, or combinations thereof, but should not be interpreted to exclude the possibility of the presence of one or more other features, figures, steps, operations, constituent elements, components, or combinations thereof.

The term “or” as used in the various embodiments of the disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3.

All terms (including technical or scientific terms) used in the disclosure have the same meaning as understood by those skilled in the art to which the disclosure belongs, unless defined differently. Common terms as defined in dictionaries are interpreted to have a meaning consistent with the context in the relevant technology art and should not be interpreted in an idealized or overly formalistic manner, unless expressly so defined in the disclosure.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through non-volatile memory, volatile memory, and the processor.

The processor may include one or more processors. At this time, the one or more processors may be a general purpose processor, such as a central processing unit (CPU), an application processor (AP), or the like, or may be a graphics-only processing unit, such as a graphics processing unit (GPU), a visual processing unit (VPU), and/or an AI-dedicated processor, such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning algorithm to a plurality of learning data, a predefined operating rule or an AI model of a desired characteristic is made. The learning may be performed in a device or electronic apparatus itself in which AI according to an embodiment is performed, and/or may be implemented through a separate server/system.

The AI model may consist of a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial networks (GAN), and a deep Q-network.

The learning algorithm is a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

According to the disclosure, at least one step, such as determining a channel type and so on, of the method performed by a network node, may be implemented using an artificial intelligence model. Processors of the electronic apparatus may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

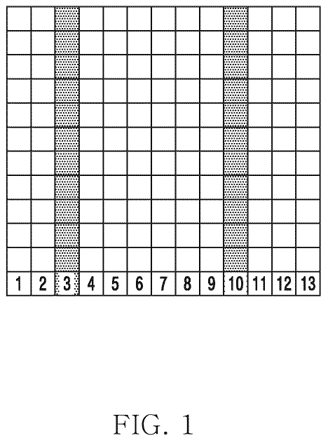

FIG. 1 is a diagram illustrating locations of DMRS symbols according to an embodiment of the disclosure.

Referring to FIG. 1, unlike architecture of a traditional radio access network (RAN), in architecture of an open radio access network (ORAN), a cyclic prefix (CP) removal module is carried out at an O-RAN radio unit (O-RU). Therefore, data at an O-RAN distributed unit (O-DU) does not contain the CP part, so channel estimation can only be implemented based on demodulation reference signal (DMRS) symbols. However, when the number and locations of the DMRS symbols are fixed, a range of frequency offset estimated based on the DMRS symbols is limited. For example, in a long term evolution (LTE) system, the locations of the DMRS symbols are at the 3^{rd} symbol and the 10th symbol, as shown in FIG. 1, and the frequency offset estimation is in a range of [−1000 Hz, 1000 Hz] according to characteristics of a frame structure. For example, the DMRS symbols may be referred to as reference symbols, or symbols of reference signals. For example, the reference signals may be used to estimate a channel between a user equipment and a base station (or a network node).

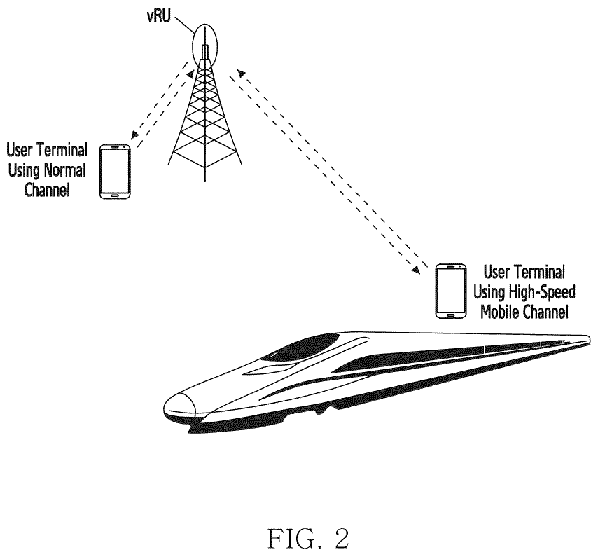

FIG. 2 is a schematic diagram illustrating an HST cell according to an embodiment of the disclosure.

Referring to FIG. 2, considering a relative location of a user equipment to a HST and a relative distance of the user equipment to a base station, a channel used by the user equipment within the HST cell may be categorized into a high-speed train channel and a non-high-speed train channel (which can also be referred to as a normal channel). As shown in FIG. 2, the HST cell contains both a user equipment with the high-speed train channel which is located on a HST train and a user equipment with the non-high-speed train channel representing slowly moving or stationary in the vicinity of the base station. For example, the non-high-speed train channel may be referred to as a normal channel.

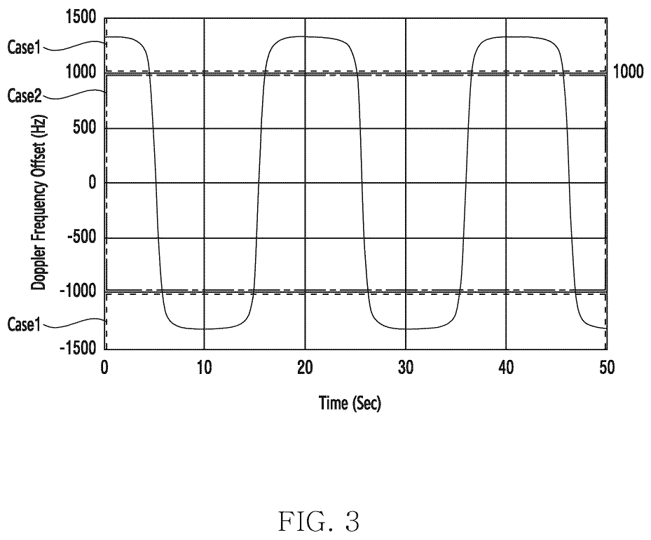

FIG. 3 is a schematic diagram illustrating a doppler frequency offset (FO) curve of a typical high-speed train channel according to an embodiment of the disclosure.

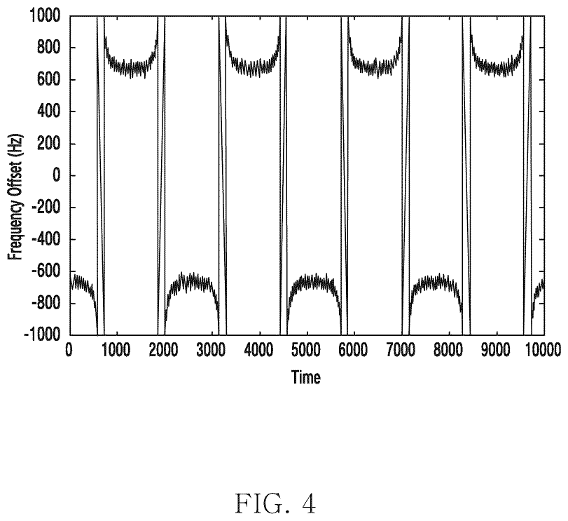

FIG. 4 is a schematic diagram illustrating a frequency offset curve estimated based on DMRS symbol according to an embodiment of the disclosure.

Referring to FIG. 3, it illustrates a typical doppler frequency offset (FO) curve of a high-speed train channel, wherein frequency offset corresponding to a blue box portion of Case1 exceed 1000 Hz, which corresponds to a case where the user equipment is in a high-speed moving high-speed train and the user equipment is far away from the base station, and a channel of this user equipment is the high-speed train channel, which has a large frequency offset at this time according to an embodiment of the disclosure.

If the frequency offset corresponding to Case1 in the blue box portion are estimated using DMRS symbols, frequency offset indicated by a blue curve as shown in FIG. 4, these frequency offsets are situated within the ranges of −600 Hz to −1000 Hz and 600 Hz to 1000 Hz, and it is obvious that there is a significant discrepancy in the frequency offsets compared with the frequency offset curve shown in FIG. 3. For example, the range of the frequency offsets of the high-speed train channel exceeds the maximum of that existing channel estimation methods can accurately measure. These erroneous frequency offsets will lead to a reduced capacity of the cell, a high rate of user access failures, and poor user experience. In FIG. 3, frequency offset corresponding to a red box portion Case2 are less than 1000 Hz. This case occurs when the user equipment is near the base station on the high-speed moving high-speed train, operating on the high-speed train channel but has a small frequency offset at this time. If the frequency offset corresponding to the red box portion Case2 is estimated using the DMRS symbols, frequency offset indicated by a red curve as in FIG. 4 is obtained, these frequency offsets fall within the range of −1000 Hz to +1000 Hz. These align with the frequency offsets corresponding to the red box portion Case2 of FIG. 3.

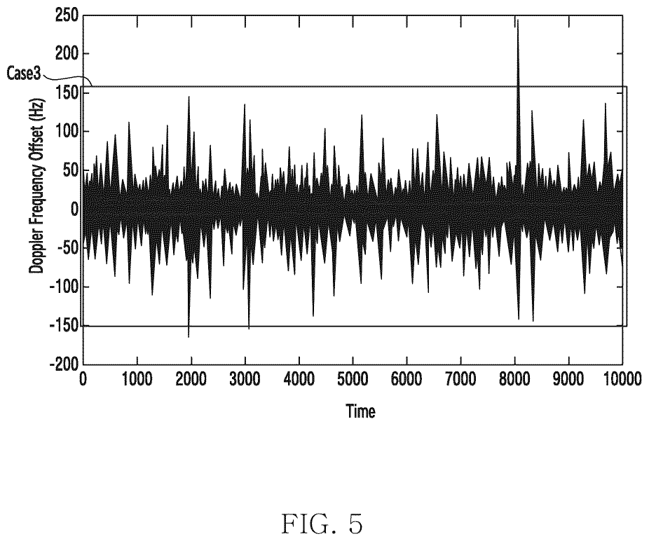

FIG. 5 illustrates a Doppler frequency offset curve of a non-high-speed train channel (i.e., a normal channel) according to an embodiment of the disclosure.

Referring to FIG. 5, the frequency offsets corresponding to a red box portion Case3 are all less than 1000 Hz, which corresponds to a case where the user equipment is either moving slowly or in a stationary state. If they are estimated using DMRS symbols, this frequency offset curve may be accurately obtained.

Based on this, the disclosure proposes a method performed by a network node. This method involves determining whether a channel used by a user equipment is a high-speed train channel or a normal channel by using an AI model when only DMRS symbols can be utilized for channel estimation. In the case of a high-speed train channel, the method identifies the frequency offset regions that require adjustment within this channel and executes frequency offset adjustments on these regions to obtain precise frequency offsets. These accurate frequency offsets are then employed for frequency offset compensation, to derive the final channel estimation value ultimately enhancing cell throughput. Conversely, if the user equipment operates on a normal channel, frequency offset compensation is directly applied using the frequency offsets of this channel to derive the final channel estimation value.

The following sections will elucidate the technical solutions and the resultant technical effects of the embodiments of this disclosure by describing several optional embodiments. It should be noted that, the following embodiments may be referred to, imitated or combined with each other, and the same term, similar features and similar implementation steps in different embodiments will not be described repeatedly.

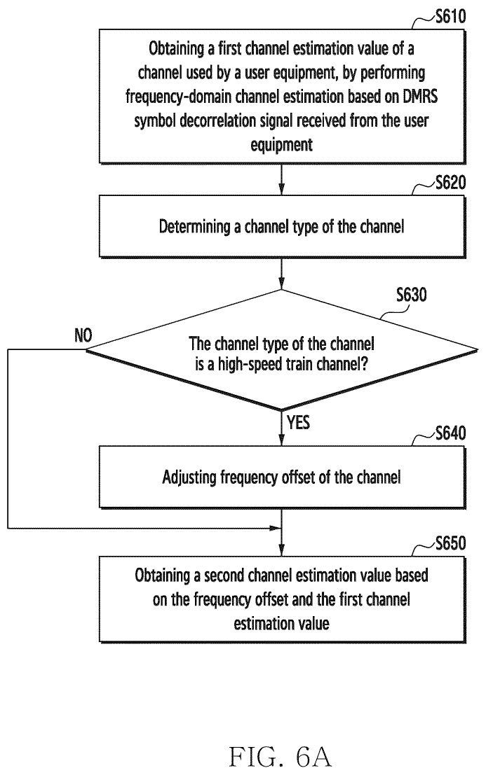

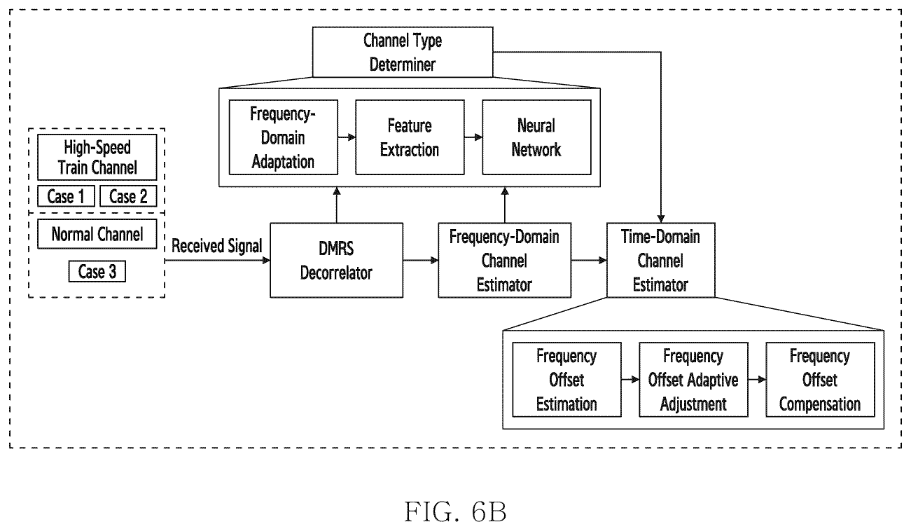

FIG. 6A is a flowchart illustrating a method performed by a network node according to an embodiment of the disclosure. FIG. 6B is a schematic diagram illustrating a channel estimation process according to an embodiment of the disclosure.

Referring to FIGS. 6A and 6B, the network node may be a base station, but the disclosure is not limited thereto, and the network node may also be a network server, which may receive various information from the base station and determine or obtain a first channel estimation value of a channel used by a user equipment according to the received various information, determine a channel type of the channel, adjust frequency offset of the channel, and obtain a second channel estimation value based on the adjusted frequency offset and the first channel estimation value, and then transmit the obtained second channel estimation value to the base station. The network node may include one entity or may include a plurality of sub-entities. When the network node includes a plurality of sub-entities, different functions may be accomplished by the plurality of sub-entities separately, and each sub-entity may have a corresponding name, and a connection between the sub-entities may be a wired connection or a wireless connection, which is not specifically limited by the disclosure. For ease of description, in the following description, the network node is the base station as an example for explanation.

Referring to FIG. 6A, at operation S610, the first channel estimation value of the channel used by the user equipment is obtained, by performing frequency-domain channel estimation based on a DMRS symbol decorrelation signal received from the user equipment.

Specifically, the decorrelation signal is obtained by performing decorrelation on the DMRS symbols received from the user equipment. As shown in FIG. 6B, the base station inputs a signal received from the user equipment to a DMRS decorrelator, wherein the signal may be a signal, which has frequency offsets as shown in FIG. 3, received from the user equipment over a high-speed train channel or a signal, which has frequency offsets as shown in FIG. 5, received from the user equipment over a normal channel. Thereafter, the base station performs a conjugate multiplication on the DMRS symbols in the received signal with DMRS symbols generated locally at the base station to obtain the decorrelation signal. For example, the decorrelation may be performed according to the following Equation 1:

$${H}_{Decorr} = q * conj ( {dmrs}_{seq} ) \qquad Equation l$$

where q denotes the DMRS symbol in the received signal, dmrs_{seq} denotes the DMRS symbol generated locally at the base station, H_{Decorr} denotes the decorrelation signal (i.e., the result of the decorrelation), and conj( ) denotes the conjugate operation.

After obtaining the decorrelation signal, as shown in FIG. 6B, firstly, a frequency-domain channel estimator may obtain a time offset regarding the channel used by the user equipment, by performing time offset estimation based on the decorrelation signal. For example, the frequency-domain channel estimator may obtain the time offset θ of the channel (which may also be referred to as an average time offset of the channel) by performing the time offset estimation using the decorrelation signal H_{Decorr} Obtained according to the above Equation 1, according to the following Equation 2:

$$θ = arctan ( {\sum }_{k = 0}^{12 * {N}_{RB} - 1} {H}_{Decorr , l} ( k ) * conj ( {H}_{Decorr , l} ( k + 1 ) ) ) \qquad Equation 2$$

where arctan ( ) denotes the operation of calculating a phase angle corresponding to a complex number by an arctangent operation, k denotes the index of a subcarrier, I denotes a location of one DMRS symbol, and N_{RB} denotes the number of allocated resource blocks (RBs).

After obtaining the time offset of the channel, the frequency-domain channel estimator may obtain the first channel estimation value of the channel by performing time offset compensation on the decorrelation signal based on the obtained time offset. For example, the frequency-domain channel estimator may obtain a channel response of the frequency-domain channel estimation, i.e., the first channel estimation value H_{FD} of the channel, by performing the time offset compensation on the decorrelation signal H_{Decorr} based on the time offset θ obtained according to the above Equation 2.

At operation S620, a channel type of the channel used by the user equipment is determined.

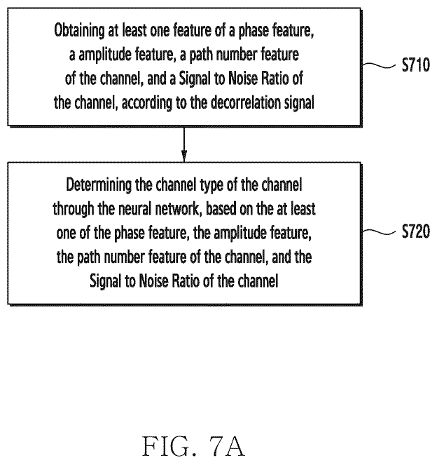

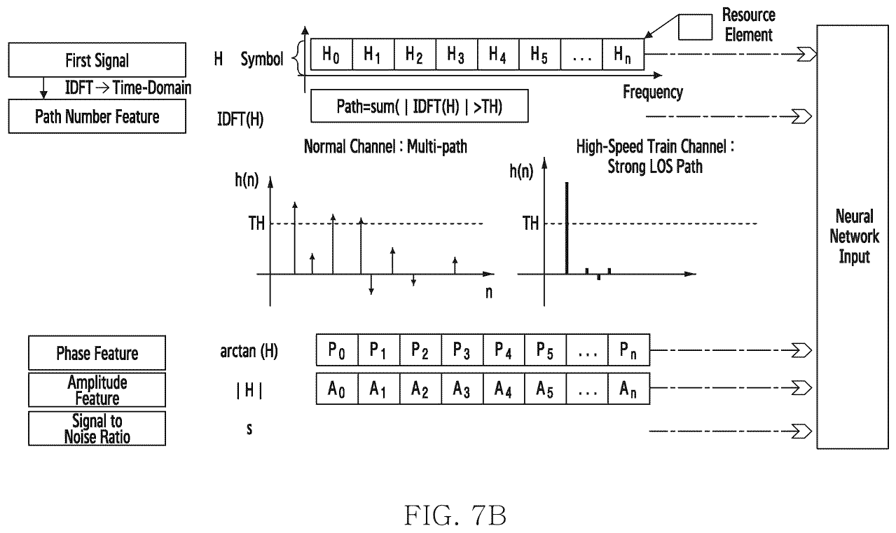

In an embodiment of the disclosure, operation S620 may include determining the channel type of the channel through a neural network based on the decorrelation signal. This is described below with reference to FIG. 7A.

FIG. 7A is a flowchart illustrating a process for determining a channel type of a channel through a neural network based on a decorrelation signal according to an embodiment of the disclosure.

Referring to FIG. 7A, at operation S710, at least one feature of a phase feature, an amplitude feature, a path number feature of the channel, and a signal to noise ratio (SNR) of the channel is obtained, according to the decorrelation signal.

The signal to noise ratio of the channel is determined according to the decorrelation signal.

In one embodiment of the disclosure, in a process of performing the frequency-domain channel estimation based on the decorrelation signal, the signal to noise ratio (SNR) of the channel may be determined by the frequency-domain channel estimator in FIG. 6B. For example, the frequency-domain channel estimator may determine the SNR s of the channel according to the following Equation 3:

$$s = Power / I \qquad Equation 3$$

wherein Power denotes a useful signal power measured by the base station for the channel used by the user equipment, and I denotes a noise power measured by the base station for the channel.

A first signal matching a frequency-domain resource dimension of the neural network may be obtained by matching a dimension of the decorrelation signal with the frequency-domain resource dimension of the neural network.

Specifically, since schedulable frequency-domain resources in a communication system are dynamically allocated, the dimension of the decorrelation signal changes accordingly. This application ensures consistency between the dimension of the decorrelation signal and input of the frequency-domain resource dimension of the neural network by aligning them, as shown in FIG. 6B, a channel type determiner may perform a frequency-domain adaptation process to match the dimension of the decorrelation signal with the frequency-domain resource dimension of the neural network, which may reduce the complexity of the neural network and facilitate the inputting to the neural network.

In an embodiment of the disclosure, the frequency-domain resource dimension of the neural network may be set to a predetermined value K. The predetermined value K may be determined according to statistical data, e.g., it may be set to 10, but the disclosure is not limited thereto, and the predetermined value K may be set accordingly based on the statistical data depending on different neural networks. In this case, a first signal matching the frequency-domain resource dimension K of the neural network may be determined by comparing the dimension of the decorrelation signal with the frequency-domain resource dimension K of the neural network, wherein the first signal may also be referred to as a frequency-domain adaption signal.

In one embodiment of the disclosure, if the dimension of the decorrelation signal is equal to the frequency-domain resource dimension K of the neural network, the decorrelation signal is determined as the first signal H matching the frequency-domain resource dimension K of the neural network, this first signal H may be subsequently inputted to the neural network to determining the channel type of the channel used by the user equipment.

If the dimension of the decorrelation signal is less than the frequency-domain resource dimension K of the neural network, the first signal H matching the frequency-domain resource dimension K of the neural network is obtained. This is achieved by extending the dimension of the decorrelation signal to the frequency-domain resource dimension K of the neural network based on the time offset of the channel determined at operation S610.

FIG. 7B is a schematic diagram illustrating a feature extraction process according to an embodiment of the disclosure.

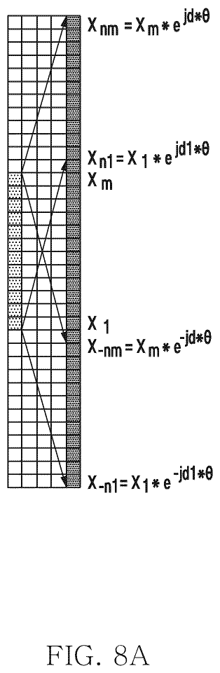

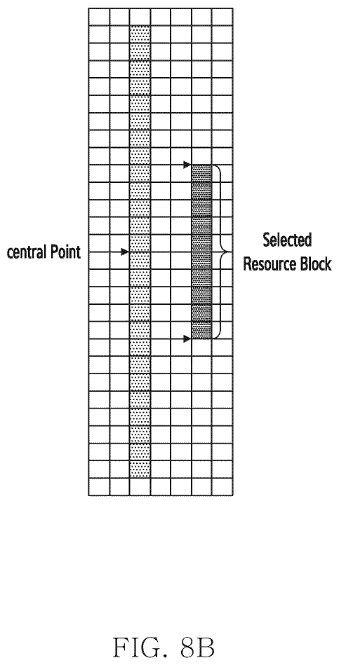

FIGS. 8A and 8B are schematic diagrams illustrating a frequency-domain adaptation process according to an embodiment of the disclosure.

Referring to FIGS. 7B, 8A, and 8B, since each symbol in the decorrelation signal corresponds to one resource element (RE) on the frequency-domain, that is, there is one symbol in the decorrelation signal on each of the REs, therefore, the dimension of the decorrelation signal may be extended by extending the assigned REs corresponding to the decorrelation signal. In one embodiment of the disclosure, as shown in part a of FIGS. 8A and 8B, the assigned REs corresponding to the decorrelation signal are extended to the frequency-domain resource dimension K of the neural network according to the time offset θ, in other words, an interpolation operation is performed on the assigned REs corresponding to the decorrelation signal according to the time offset, and accordingly, the decorrelation signal with the extended dimension, i.e., the first signal H, is obtained.

For example, the extended frequency-domain resources may be represented as:

$${x}_{n m} = {x}_{m} * {e}^{jd * θ} \qquad Equation 4$$

where xₘ denotes the m-th RE assigned for the user equipment; xₙₘ denotes the m-th RE in the n-th extended RB; d denotes a frequency-domain distance from xₘ to xₙₘ; and θ denotes the time offset of the frequency-domain channel estimation, i.e., the time offset obtained by the above Equation 2. In addition, d1in FIG. 8A denotes a frequency-domain distance from x₁ to xₙ₁.

For example, it is assumed that the number of the REs on the frequency-domain (i.e., the REs corresponding to the decorrelation signal) assigned for the user equipment is 12 REs (i.e., 1 RB), i.e., x=[x₀,x₁, . . . , x₁₁]∈ [symbol] ¹², and if the frequency-domain resource dimension K of the neural network is 24 REs (i.e., 2 RBs), it is needed to extend the REs on the frequency-domain assigned for the user equipment, and the extended frequency-domain resources may be denoted as:

$$X = [ {x}_{0} , {x}_{1} , … , {x}_{11} , {x}_{0} {e}^{j 12 θ} , {x}_{1} {e}^{j 12 θ} , … , {x}_{11} {e}^{j 12 θ} ] ∈ {ℂ}^{24} \qquad Equation 5$$

Since the frequency-domain resources (i.e., the allocated REs) have been extended and there is the corresponding symbol on each extended RE, the extended decorrelation signal, i.e., the first signal H, may be obtained accordingly.

Further, if the dimension of the decorrelation signal exceeds the frequency-domain resource dimension K of the neural network, a segment is extracted from the decorrelation signal based on the frequency-domain resource dimension of the neural network to serve as the first signal H. Due to the correspondence between the symbol in the decorrelation signal and the RE, the dimension of the decorrelation signal can be reduced by extracting REs equivalent to frequency-domain resource dimension K of the neural network from the assigned REs corresponding to the decorrelation signal. In one embodiment of the disclosure, as shown in FIG. 8B, REs (for example, in a central portion) matching the frequency-domain resource dimension K of the neural network are intercepted from the assigned REs corresponding to the decorrelation signal, resulting in a plurality of symbols in the decorrelation signal which correspond to the REs in the central portion may be obtained as the first signal H.

For example, it is assumed that the number of REs allocated for the user equipment is 36 REs (i.e., 3 RBs), i.e., x=[x₀,x₁, . . . , x₃₅]∈ [symbol] ³⁶, and if the frequency-domain resource dimension K of the neural network is 12 REs (i.e., 1 RB), the REs allocated for the user equipment need to be cut back, i.e., the REs in the central portion are intercepted, and in this case, the intercepted REs may be denoted as:

$$X = [ {x}_{12} , {x}_{13} , {x}_{14} , {x}_{15} , {x}_{16} , {x}_{17} , {x}_{18} , {x}_{19} , {x}_{20} , {x}_{21} , {x}_{22} , {x}_{23} ] ∈ {ℂ}^{12} \qquad Equation 6$$

Since the frequency-domain resources (i.e., the allocated REs) have been reduced, and the corresponding symbols are present on all the reduced REs, the reduced decorrelation signal, i.e., the first signal H, may be obtained accordingly.

In summary, the first signal H matching the frequency-domain resource dimension K of the neural network may be obtained by the above process.

Thereafter, at least one of the phase feature and the amplitude feature of the first signal on each RE and the path number feature of the channel is extracted, according to the first signal. As shown in FIG. 6B, in a channel type determiner, a feature extraction operation is performed on the first signal H obtained by the frequency-domain adaptation operation, to obtain at least one of the phase feature, the amplitude feature, and the path number feature.

Specifically, the extracting the path number feature of the channel, according to the first signal, includes: determining an amplitude of a time-domain pulse response of the channel using the first signal; extracting the path number feature of the channel according to the count of the amplitudes of the time-domain pulse response that exceeds a predetermined threshold.

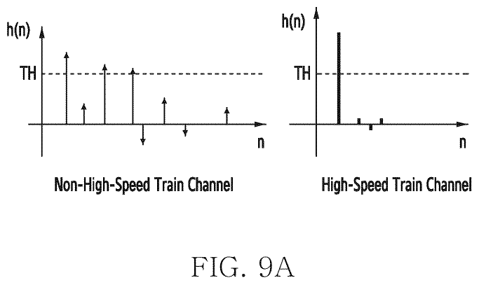

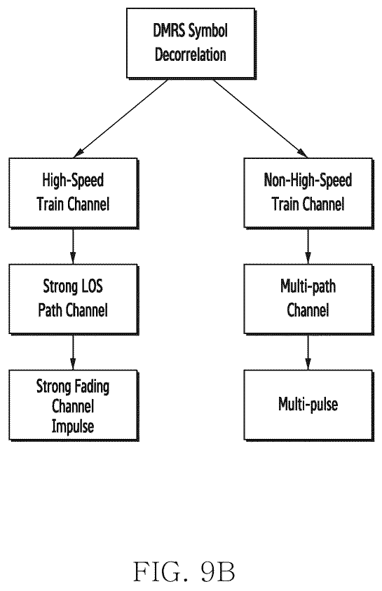

FIGS. 9A and 9B are diagrams illustrating time-domain pulse responses and characteristics of a high-speed train channel and a non-high-speed train channel according to an embodiment of the disclosure.

In an embodiments of the disclosure, the amplitude of the time-domain pulse response of the channel may be determined according to the following Equation 7, wherein IDFT denotes an inverse discrete Fourier transform, ∥ denotes a modulo operation, n denotes the number of points of a Fourier transform, and a sequence value of h(n) denotes the amplitude of the time-domain pulse response of the channel.

$$h ( n ) = \vert IDFT ( H , n ) \vert \qquad Equation 7$$

In addition, as shown in FIGS. 9A and 9B, for the non-high-speed train channel (i.e., a normal channel), the presence of abundant scatterers in the cell often results in multipath conditions along the propagation path, where the count at which the amplitude of the time-domain pulse response exceeds the first predetermined threshold is high, indicating that h(n) displays multiple peak values. However, for the high-speed train channel, since the base station is set up, e.g., around railroad tracks, a signal propagation environment is open, there are usually strong line of sight (LOS) path channels between the base station and the user equipment. Therefore, the count that the amplitude of the time-domain pulse response exceeds the first predetermined threshold is small, i.e., h(n) shows a single peak value. Therefore, the presence of an effective path can be determined if a certain time-domain pulse response's amplitude exceeds the first predetermined threshold. The path number feature of the channel may be determined, by the count of the amplitude h(n) of the time-domain pulse response that exceeds the first predetermined threshold. For example, the path number feature path of the channel may be determined according to the following Equation 8, e.g., as illustrated in FIG. 7B, wherein sum denotes a summation operation, and TH denotes the first predetermined threshold which is settable.

$$path = sum ( h ( n ) > TH ) \qquad Equation 8$$

In an embodiment of the disclosure, the amplitude feature A and the phase feature φ of the first signal at each RE corresponding thereto may be extracted according to the following Equations 9 and 10, respectively:

$$A = \vert H \vert \qquad Equation 9$$

$$φ = arctan ( H ) \qquad Equation 10$$

where arctan denotes an arctangent operation, such as shown in FIG. 7B.

For example, it is assumed that the first signal H=[H₀, H₁, . . . , H₁₁]∈ [symbol] ¹² matching the frequency-domain resource dimension K of the neural network is obtained by the previous matching operation, in this case, after the inverse Fourier transform IDFT of H using Equation 7, the path number feature Path may be denoted as the number that modulus values via IDFT are greater than the first predetermined threshold TH, according to the above Equation 8, and according to the above Equation 9, the amplitude feature A may be denoted as A=[A₀, A₁, . . . , A₁₁]=[|H₀|, |H₁|, . . . , |H₁₁|]∈ [symbol] ¹² and the phase feature φ may be denoted as φ=[φ₀,φ₁, . . . , φ₁₁]=[arctan (H₀), arctan (H₁), . . . , arctan (H₁₁)]∈ [symbol] ¹².

Through the above process, the phase features and the amplitude feature of the first signal at each RE, and the path number feature of the channel may be extracted, as shown in FIG. 7B.

Referring back to FIG. 7A, at operation S720, the channel type of the channel is determined through the neural network, based on at least one of the phase feature, the amplitude feature, the path number feature of the channel, and the SNR of the channel.

In one embodiment of the disclosure, to determine the channel type of the channel using the neural network, the obtained feature(s) from operation S710 are input into the neural network. Additionally, the first signal derived from the matching operation described earlier is also input into the neural network. Subsequently, the neural network predicts the channel type of the channel based on both the input feature(s) and the input first signal.

Specifically, as shown in FIG. 7B, at least one of the phase feature o, the amplitude feature A, and the path number feature path extracted by the feature extraction operation, and the SNR s of the channel obtained by the frequency-domain channel estimator as well as the first signal H are inputted into the neural network for the channel type prediction For example, it may be set to indicate that the channel is the high-speed train channel when an output of the neural network is 1, and the channel is the non-high-speed train channel (i.e., a normal channel) when the output of the neural network is 0. In the disclosure, the neural network may be a support vector machine (SVM), a convolutional neural networks (CNN), a recurrent neural network (RNN), a long short-term memory (LSTM) network, a multilayer perceptron mixer (MLP-Mixer), a transformer network, or the like, but the disclosure is not limited thereto. In the disclosure, the SNR s is introduced as an indicator of parameters of the neural network, and the parameters of the neural network may be dynamically adjusted according to the change of the SNR s, which in turn may enhance the robustness to the noise environment.

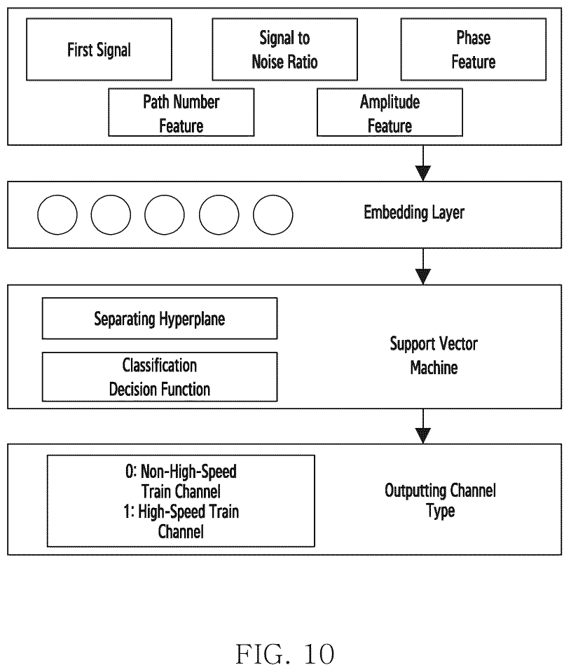

FIG. 10 is a schematic diagram illustrating a channel type determiner based on a support vector machine according to an embodiment of the disclosure.

Referring to FIG. 10, for example, a process for determining the channel type of the channel is described using the neural network as a support vector machine as an example. As shown in FIG. 10, firstly, a normalization operation is performed on the phase feature, the amplitude feature, the path number feature of the channel, the SNR of the channel, and the first signal H obtained by the matching operation described above, and each of the normalized data described above is inputted to an embedding layer. Then, each of the input data is fused by the embedding layer, and the fusion result is input to the support vector machine. Afterwards, the channel type of the channel is determined by the support vector machine based on the received fusion result, for example, when an output of the support vector machine is 1, it indicates that the channel type of the channel is the high-speed train channel, while an output of 0 signifies the non-high-speed train channel (i.e., a normal channel).

Furthermore, the support vector machine used above may be a support vector machine obtained by offline training, and as shown in FIG. 10, the support vector machine may be provided with a separating hyperplane and a classification decision function, wherein a kernel function in the classification decision function may employ, for example, a Gaussian kernel function as shown in Equation 11 below:

$$K ( {x}^{′} , z ) = exp ( - \frac{{‖ {x}^{′} - z ‖}^{2}}{2 {σ}^{2}} ) \qquad Equation 11$$

Wherein x′ and z denote two input data points; |x′−z| denotes a distance representation between these two data points x′ and z in a Gaussian space; and σ denote a parameter of the Gaussian kernel function, which is used to control a density of Gaussian distribution. In addition, a cross-entropy function of the channel type shown in Equation 12 below is used as a loss function when training the Support Vector Machine:

$$Loss = - ( y \cdot log ( \hat{y} ) + ( 1 - y ) \cdot log ( 1 - \hat{y} ) ) \qquad Equation 12$$

wherein ŷ denotes a probability that a predicted sample of the neural network (i.e., support vector machine) is a positive example and y denotes a sample label. The trained neural network may be obtained after several rounds of iterative training, based on the loss function indicated by the above Equation 12.

Referring back to FIG. 6A, at operation S630, it is determined whether the channel type of the channel is the high-speed train channel. When the channel type of the channel is a high-speed train channel, it may proceed to operation S640.

At operation S640, the frequency offset of the channel are adjusted, i.e., a frequency offset adaptive adjustment as shown in FIG. 6B is performed.

As shown in FIG. 6B, before performing operation S640, it is needed to perform frequency offset estimation, i.e., estimating the frequency offsets regarding the channel.

Specifically, an accumulated value FOₑₛₜ is obtained by conjugate multiplication and accumulation of data, at two DMRS symbol locations, of the first channel estimation value H_{FD} obtained through the frequency-domain channel estimation according to Equation 13 below:

$$F {O}_{e s t} = {\sum }_{k = 0}^{12 * {N}_{R B} - 1} {H}_{FD , l 1 = 3} ( k ) * conj ( {H}_{FD , l 2 = 10} ( k ) ) \qquad Equation 13$$

Wherein l1 and l2 denote the locations of the two DMRS symbols, e.g., for the example illustrated in FIG. 1, l1 is 3 and l2 is 10; N_{RB}, k, and conj have the same meanings as those of the symbols in the above Equation 2.

Then, the phase σ′ is obtained for the accumulated value FOₑₛₜ, and based on this, a frequency offset fo of the channel is estimated according to the following Equation 14:

$$fo = {φ}^{′} / 2 πΔ t \qquad Equation 14$$

Wherein Δt indicates a time interval between the two DMRS symbols.

In the disclosure, the estimating frequency offset of channel may be performed after the operation S630 and before the operation S640, or may be performed before the operation S630, and the disclosure does not specifically limit to this. The process for adjusting the frequency offset of the channel is described specifically below.

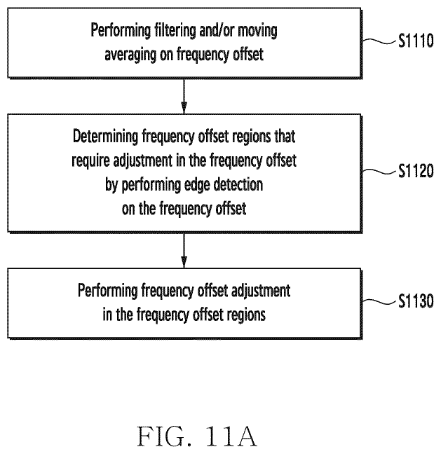

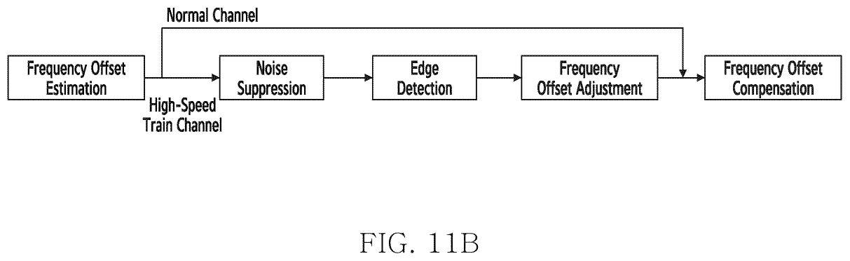

Specifically, the step of adjusting the frequency offset may include: determining frequency offset regions that require adjustment in the frequency offset fo; performing adjustment on frequency offset fo in the frequency offset regions. The process of determining the frequency offset regions that require adjustment in the frequency offset fo is described below with reference to FIGS. 11A and 11B.

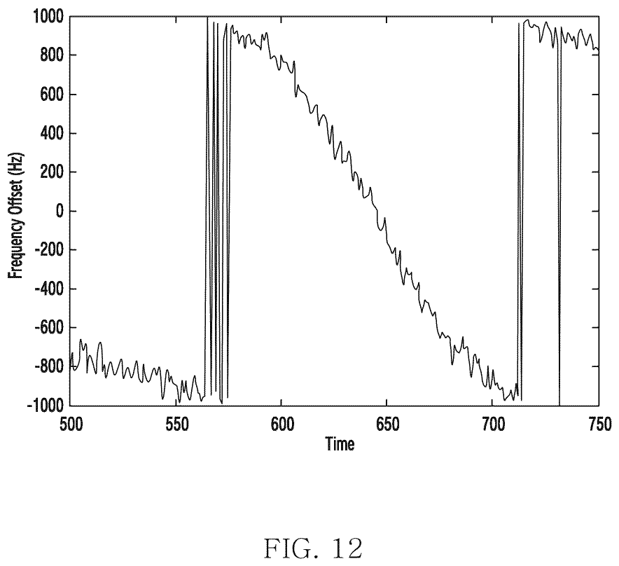

FIG. 11A is a flowchart illustrating a process for adjusting frequency offset according to an embodiment of the disclosure. FIG. 11B is a schematic diagram illustrating a process for adjusting (i.e., adaptively adjusting) frequency offset according to an embodiment of the disclosure. FIG. 12 is a schematic diagram illustrating an estimated frequency offset curve at a high-speed train channel according to an embodiment of the disclosure.

Referring to FIGS. 11A, 11B, and 12, at operation S1110, filtering and/or moving average is performed on the frequency offset fo, thereby obtaining frequency offset with suppressed noise.

As shown in FIG. 11B, when the channel type of a user equipment is the high-speed train channel, a noise suppression operation may be performed after the frequency offset estimation. Specifically, due to the effect of noise, a curve of the estimated frequency offset fo before operation S640 has many burrs and there is a plurality of oscillations at the location of frequency equal to ±1000 Hz, as shown in FIG. 12, wherein a vertical axis of FIG. 12 represents frequency offset estimated by the two DMRSs. In order to minimize the effect of noise, the filtered frequency offset may be obtained by firstly performing filtering on the frequency offset according to the following Equation 15.

$$Filter\_fo ( t ) = ( 1 - α ) * fo ( t ) + α * fo ( t - 1 ) \qquad Equation 15$$

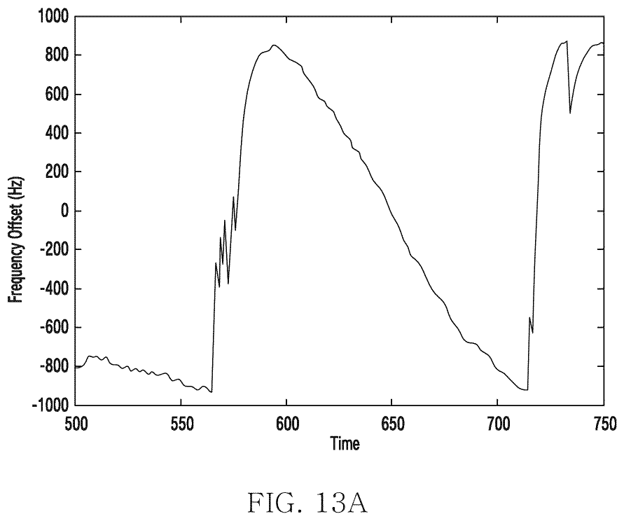

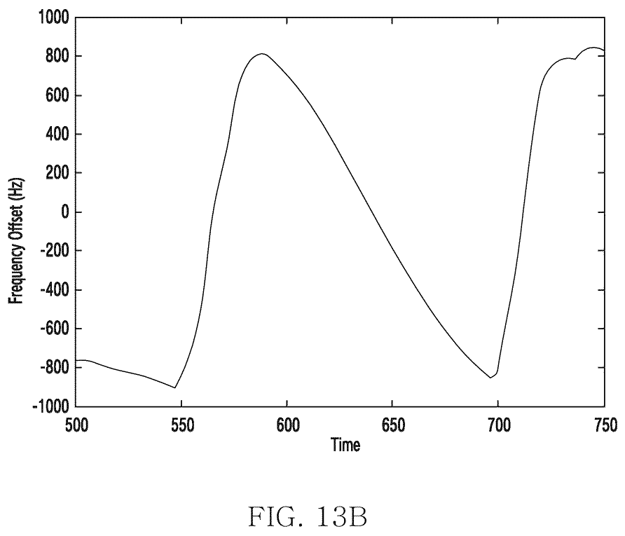

FIGS. 13A and 13B are schematic diagrams illustrating a frequency offset curve, in which noise is suppressed, according to an embodiment of the disclosure.

Referring to FIGS. 13A and 13B, wherein α denotes a filter parameter, fo(t) denotes the estimated frequency offset at the current moment t, fo(t−1) denotes the estimated frequency offset at the previous moment t−1, and Filter_fo(t) denotes the filtered frequency offset at the current moment t. FIG. 13A illustrates the filtered frequency offset. Then, the frequency offset after noise suppression are obtained by performing moving averaging on the filtered frequency offset according to the Equation 16 below.

$$MA\_fo ( t ) = \frac{1}{{N}_{w i n}} {\sum }_{1}^{{N}_{win}} Filter\_fo ( t ) \qquad Equation 16$$

Wherein N_{win} is the length of moving window and MA_fo(t) denotes the frequency offset in which the noise is suppressed at the current moment t. FIG. 13B illustrates the frequency offset after moving averaging, i.e., the frequency offset in which the noise is suppressed.

For example, for HST scenario 3, the maximum doppler frequency offset is 1340 Hz. At this time, the filter parameter a in Equation 15 may be set to 0.8, and the window length N_{win} of moving averaging is set to 10, then the filtered frequency offset Filter_fo(t) at the current moment t is denoted as Equation 17 below, and accordingly, the frequency offset after noise suppression may be denoted as Equation 18 below:

$$Filter\_fo ( t ) = 0.2 * f o ( t ) + 0.8 * fo ( t - 1 ) \qquad Equation 17$$

$$MA\_fo ( t ) = \frac{1}{10} {\sum }_{1}^{10} Filter\_fo ( t ) \qquad Equation 18$$

At operation S1120, the frequency offset regions that require adjustment in the frequency offset are determined by performing edge detection on the frequency offset.

As shown in FIG. 11B, after the noise suppression operation is performed, the edge detection operation is performed. Specifically, firstly, slopes of the frequency offsets in which the noise is suppressed are calculated, i.e., a slope of a curve of the frequency offsets in which the noise is suppressed is calculated, for example, the slope slop(t) of the curve of the frequency offset is calculated according to the following Equation 19:

$$slop ( t ) = \frac{MA\_fo ( t ) - MA\_fo ( t - 1 )}{Δ t 1} \qquad Equation 19$$

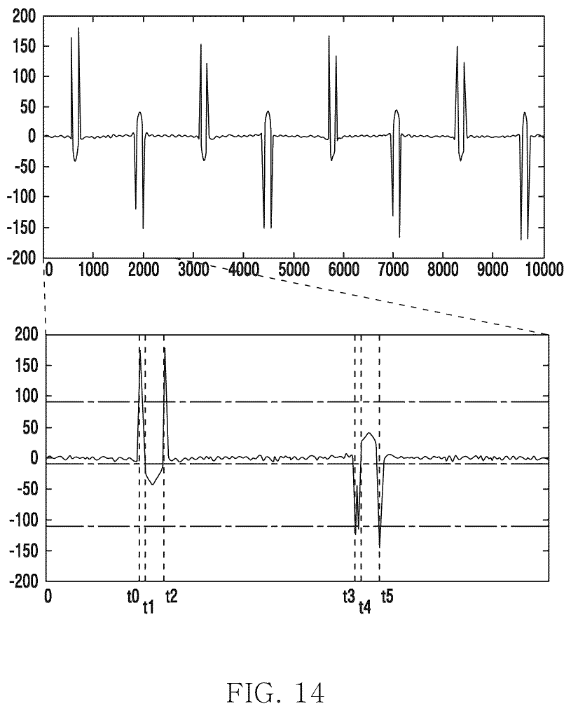

FIG. 14 is a schematic diagram illustrating a slope curve of a frequency offset curve according to an embodiment of the disclosure.

Referring to FIG. 14, wherein Δt1 is a fixed value, e.g., may be set to 1, but the disclosure is not limited thereto. FIG. 14 is a schematic diagram illustrating a slope curve of a frequency offset curve according to an embodiment of the disclosure.

Then, positive jumping edges and negative jumping edges of the frequency offsets can be determined according to the slopes of the frequency offsets.

Specifically, as may be seen from FIG. 14, the slope curve is periodic, and each period contains two positive pulses and two negative pulses, wherein the positive pulse represents a positive jumping edge of the frequency offset curve, and the negative pulse represents a negative jumping edge of the frequency offset curve. The process of detecting the positive jumping edges and the negative jumping edges is described below. An initial value of Marker is set to 0, and if the following conditions (1) and (2) are satisfied, it is considered that the first positive jumping edge is detected:

(1) Marker of the previous moment t−1 is 0, i.e., Marker (t−1)=0;

(2) An absolute value of the slope of the frequency offset curve at the current moment t slop(t) is greater than a second predetermined threshold slop_TH, i.e., slop(t)>slop_TH, wherein slop_TH may be set to, for example, 200, but the disclosure is not limited thereto.

When the first positive jumping edge is detected (e.g., the first positive jumping edge is detected at t0 in FIG. 14), Marker at the current moment t is set to 1. Then, the detection of the case in which the slope of the frequency offset curve is less than 0 is started, and when the slope is detected to be less than 0 (e.g., the slope of the frequency offset curve is detected to be less than 0 at t1 in FIG. 14), the detection of the second positive jumping edge of the frequency offset curve is started. The value of Marker is maintained at 1 until the second positive jumping edge is detected, and if the following conditions (3) and (4) are satisfied, it considers that the second positive jumping edge is detected.

(3) Marker of the previous moment t−1 is 1, i.e., Marker (t−1)=1;

(4) The absolute value of slope of the frequency offset curve at the current moment t slop(t) is greater than the second predetermined threshold slop_TH, i.e., slop(t)>slop_TH.

When the second positive jumping edge is detected (e.g., the second positive jumping edge is detected at t2 in FIG. 14), Marker at the current moment t is set to 0. Then, the detection of the first negative jumping edge is started, and the detection method of the negative jumping edge is the same as that of the positive jumping edge, i.e., if the above conditions (1) and (2) are satisfied, it considers that the first negative jumping edge is detected.

When the first negative jumping edge is detected (e.g., the first negative jumping edge is detected at t3 in FIG. 14), Marker at the current moment t is set to 1. Then, the detection of the case in which the slope of the frequency offset curve is greater than 0 is started. When the slope of the frequency offset curve is detected to be greater than 0 (e.g., the slope of the frequency offset curve is detected to be greater than 0 at t4 in FIG. 14), the detection of the second negative jumping edge of the frequency offset curve is started. The value of Marker is maintained at 1 until the second negative jumping edge is detected, and if conditions (3) and (4) above are satisfied, it considers that the second negative jumping edge is detected (e.g., the second negative jumping edge is detected at t5 in FIG. 14).

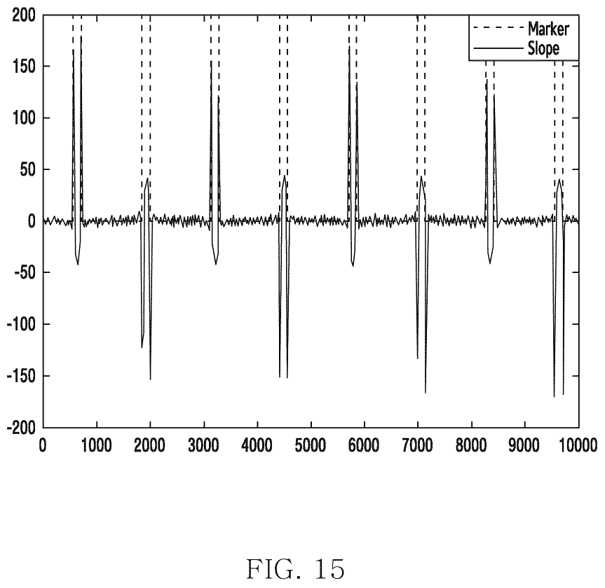

FIG. 15 is a schematic diagram illustrating a Marker curve according to an embodiment of the disclosure.

Referring to FIG. 15, the above process shows that Marker is 1 between two adjacent positive pulses and is 1 between two adjacent negative pulses, and is 0 between a positive jumping edge and a negative jumping edge which are adjacent, so Marker curve shown in FIG. 15 may be obtained. In other words, after determining the positive and negative jumping edges of the frequency offsets, the region between a positive jumping edge and the adjacent negative jumping edge, are determined as the frequency offset regions that requiring adjustment.

In an embodiment of the disclosure, the frequency offset curve is divided into three regions according to values of Marker and the sign of estimated frequency offset fo(t), and then the frequency offset regions requiring adjustment are determined. Specifically, the frequency offset curve may be divided into three regions as follows:
Region 1: Marker=0 and frequency offset fo(t) is negative;
Region 2: Marker=1;
Region 3: Marker=0 and the frequency offset fo(t) is positive.

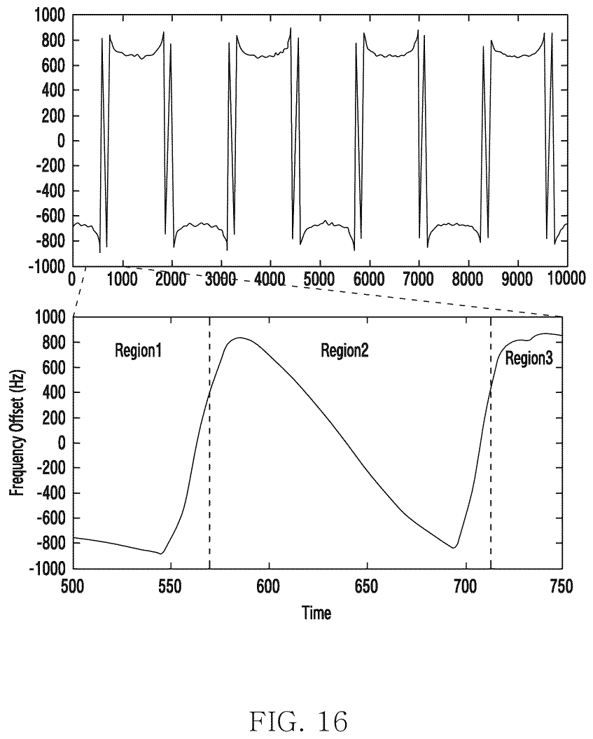

FIG. 16 is a schematic diagram illustrating the division of a frequency offset curve according to an embodiment of the disclosure.

Referring to FIG. 16, that is, both Region 1 and Region 3 are regions between the positive jumping edge and the adjacent negative jumping edge, and Region 2 is a region between two adjacent positive jumping edges or a region between two adjacent negative jumping edges, as shown in FIG. 16. In FIG. 16, an upper diagram shows the estimated frequency offset curve over 10,000 time to interactive (TTI), and the lower diagram shows a zoomed-in view near the first jumping edge. As may be seen in FIG. 16, the frequency offset in Region 1 and Region 3 are regions in which frequency offset fo(t) requires adjustment (hereinafter referred to as “frequency offset regions to be adjusted”), and the frequency offset fo(t) in Region 2 does not need to be adjusted.

At operation S1130, frequency offset adjustment is performed on the frequency offset regions determined at operation S1120.

As shown in FIG. 11B, after the frequency offset regions that requiring adjustment are determined by performing the edge detection operation, the frequency offset adjustment operation is performed. Specifically, the adjusting process of the frequency offset regions requiring adjustment includes: decreasing positive fo(t) in the frequency offset regions requiring adjustment by the first predetermined value, and increasing negative fo(t) in the frequency offset regions requiring adjustment by the first predetermined value.

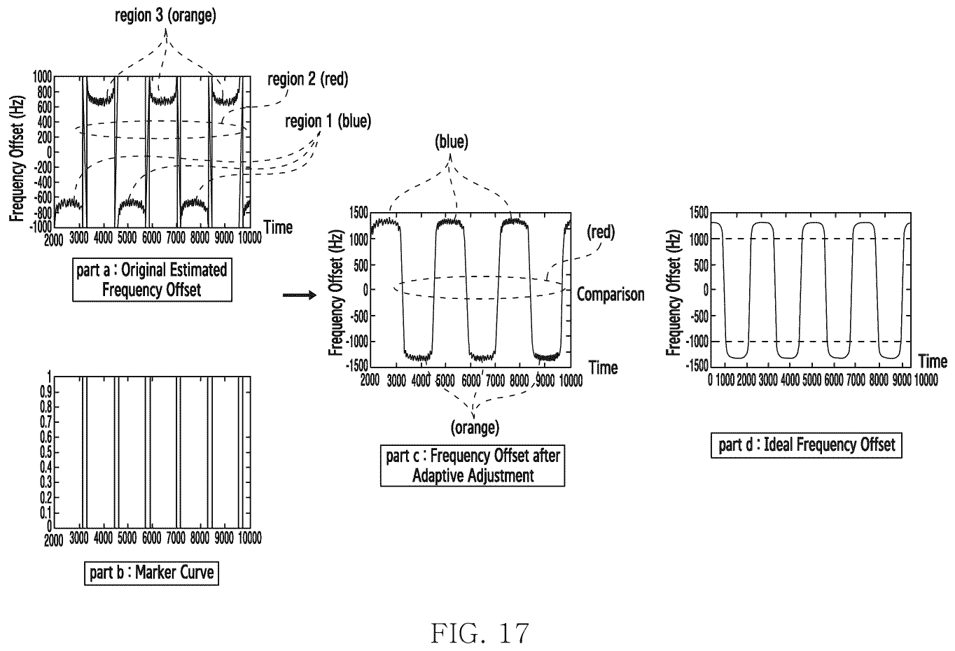

FIG. 17 is a schematic diagram illustrating a process, result, and comparison of adaptive adjustment of a frequency offset curve according to an embodiment of the disclosure.

Referring to FIG. 17, for Region 1 in the frequency offset regions requiring adjustment (i.e., the frequency offset fo(t) is negative and Marker is 0 in this region, such as blue areas in part a of FIG. 17 indicated by the Marker curve in part b of FIG. 17), frequency offset fo(t) in Region 1 are increased by the first predetermined value (e.g., 2,000 Hz) as shown in blue areas in part c of FIG. 17; for Region 3 in the frequency offset regions requiring adjustment (i.e., the frequency offset fo(t) is positive and Marker is 0 in this region, such as orange areas in part a of FIG. 17 indicated by the Marker curve in part b of FIG. 17), frequency offset fo(t) in Region 3 are reduced by the first predetermined value (e.g., 2000 Hz), as shown in orange areas of part c of FIG. 17; and for Region 2, no adjustment is needed, as shown in red areas of part c of FIG. 17. After above adjustment, a curve of adjusted frequency offset is shown in part c in FIG. 17. It can accurately reflect ideal frequency offsets which is shown in part d in FIG. 17. The adjusted frequency offset is used to perform the frequency offset compensation as shown in FIG. 11B, which is described below.

Returning to the reference to FIG. 6A, after performing operation S640, operation S650 is performed to obtain a second channel estimation value based on the adjusted frequency offset and the result of the frequency-domain channel estimation values.

As shown in FIG. 6B, the frequency offset compensation is performed after the frequency offset adaptive adjustment is performed, specifically, the second channel estimation value is obtained based on the adjusted frequency offset and the first channel estimation value.

For example, the second channel estimation value h_foc may be obtained by performing frequency offset compensation on the above first channel estimation value H_{FD} of the frequency-domain channel estimation obtained at operation S610 according to the following Equation 20.

$$h\_foc = h * {e}^{- j * 2 π * fo * t} \qquad Equation 20$$

Wherein fo denotes a frequency offset used for frequency offset compensation and t denotes a time interval between each OFDM symbol and the frame header.

Furthermore, at operation S630, when the channel type is not the high-speed train channel (i.e., is a normal channel), it may proceed directly to operation S650, for example, as shown in FIG. 11B, when the channel type is normal channel, the second channel estimation value may be obtained based on the estimated frequency offset fo(t) and the first channel estimation value, i.e., the estimated frequency offset fo(t) in above Equation 14 is used to perform frequency offset compensation on the first channel estimation value. For example, without adjusting the frequency offsets determined according to the above Equation 14, the second channel estimation value is obtained by performing the frequency offset compensate on the first channel estimation value, based on the frequency offsets, using the Equation 20.

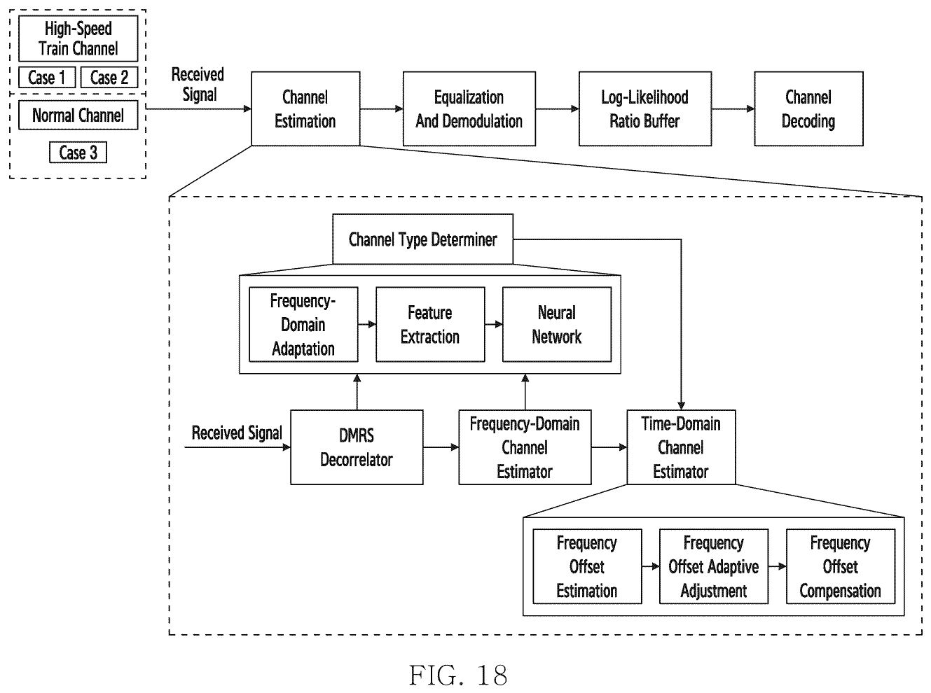

FIG. 18 is a diagram illustrating a system (e.g., a physical uplink shared channel (PUSCH) receiver) in which a method performed by a network node according to an embodiment of the disclosure.

Referring to FIG. 18, a base station receives a signal from a user equipment, and then the base station performs channel estimation based on the received signal. Specifically, DMRS decorrelator obtains decorrelation signal by decorrelating DMRS symbols in the received signal, and then frequency-domain channel estimator obtains a first channel estimation of the channel used by the user equipment by performing frequency-domain channel estimation based on the decorrelation signal, after which, a channel type determiner determines a channel type of the channel based on the decorrelation signal received from the DMRS decorrelator and a time offset and a SNR received from the frequency-domain channel estimator, then a time-domain channel estimator performs time-domain channel estimation according to the channel type of the channel. Specifically, if the channel type of the channel is a normal channel, the time-domain channel estimator obtains a second channel estimation value, by directly using frequency offset of the channel to perform frequency offset compensation on the first channel estimation value as shown in operation S650 above, and if the channel type of the channel is a high-speed train channel, the time-domain channel estimator obtains the second channel estimation value, by firstly adjusting the frequency offset of the channel as shown in operation S640 above and then using the adjusted frequency offset to perform the frequency offset compensation on the first channel estimation value. Since the channel estimation process is described above with reference to FIG. 6A, it will not be repeated here.

After the base station obtains the second channel estimation value, the base station performs equalization and demodulation, log-likelihood ratio buffer, and channel decoding according to existing methods.

The method performed by a network node proposed in the disclosure may effectively improve a Doppler compensation accuracy, which in turn improves channel estimation accuracy, resulting in the improvement of system throughput; and the disclosure, by extracting a path number feature as a main feature and input it into a neural network, may effectively extract a propagation difference between a non-high-speed train channel and a high-speed train channel, and further input a phase feature, an amplitude feature, and a Signal to Noise Ratio feature of a signal used as auxiliary features into the neural network so as to help the neural network learn characters of data faster and better, which improves a robustness of the neural network for different environments and different noise scenarios, and further improves a system capacity. In addition, the process of firstly determining a channel type (which may also be referred to as categorizing a channel) and then processing the signal according to the channel type, which is adopted in the method performed by the network node of the disclosure, reduces the number of retransmissions of the system and reduces complexity of the system. In addition, an edge detection operation in channel estimation method of the disclosure may accurately identify a change trend of frequency offset in a high-speed train channel, distinguish different frequency offset regions and adjust the frequency offset accordingly, thereby obtaining accurate frequency offset for frequency offset compensation, and ultimately obtain an accurate channel estimation value.

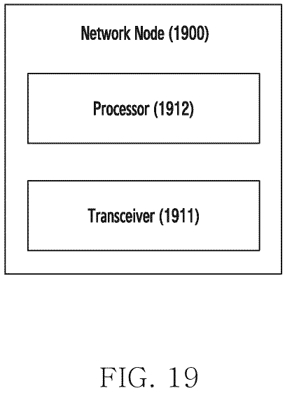

FIG. 19 is a block diagram illustrating a network node according to an embodiment of the disclosure.

Referring to FIG. 19, a network node 1900 includes a transceiver 1911 and a processor 1912, wherein the processor 1912 is coupled to the transceiver 1911 and configured to perform the method performed by the network node described above with reference to FIGS. 6A, 6B, 7A, 7B, 8 to 10, 11A, 11B and 12 to 17. Details regarding the operations of the above-described method performed by the network node may be found in the descriptions of FIGS. 6A, 6B, 7A, 7B, 8 to 10, 11A, 11B and 12 to 17, none of which will be repeated herein.

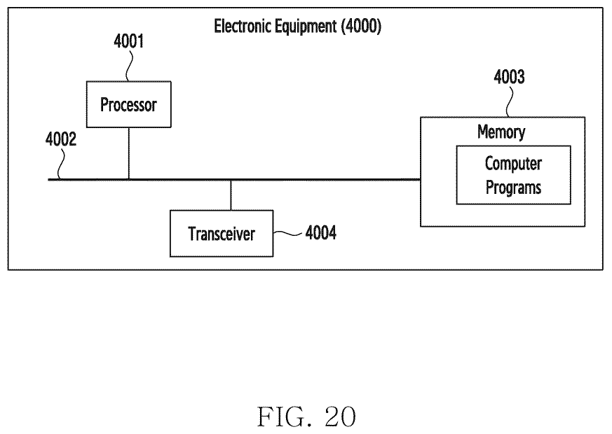

An embodiment of the disclosure also provides an electronic equipment including at least one processor, alternatively, further including at least one transceiver and/or at least one memory coupled to the at least one processor, the at least one processor is configured to perform the steps of the method provided in any alternative embodiment of the disclosure. For example, the network node 1900 may be an example of the electronic equipment in FIG. 20.

FIG. 20 illustrates a schematic diagram of a structure of an electronic equipment applicable according to an embodiment of the disclosure.

Referring to FIG. 20, an electronic equipment 4000 shown in FIG. 20 includes a processor 4001 and memory 4003. Wherein the processor 4001 and the memory 4003 are coupled, e.g., through a bus 4002. Alternatively, the electronic equipment 4000 may further include a transceiver 4004 which may be used for data interaction between the electronic equipment and other electronic equipment, such as transmitting of data and/or receiving of data. It should be noted that, each of the processor 4001, the memory 4003, and the transceiver 4004 is not limited to one in a practice application, and the structure of the electronic equipment 4000 does not constitute a limitation of the embodiments of the disclosure. Alternatively, the electronic equipment may be the first network node, the second network node, or the third network node. For example, the electronic device may be a network node, a base station, or a user equipment (UE).

The processor 4001 may be a central processing unit (CPU), general purpose processor, digital signal processor (DSP), application specific integrated circuit (ASIC), field programmable gate array (FPGA) or other programmable logic device, transistor logic device, hardware part, or any combination thereof. It may implement or perform various logic boxes, modules, and circuits described in conjunction with the disclosed contents of the disclosure. The processor 4001 may also be a combination that implements computing functions, such as a combination containing one or more microprocessors, a combination of a DSP and a microprocessor, and the like. The processor 4001 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a pathway to transfer information between the above components. The bus 4002 may be a peripheral component interconnect (PCI) bus or an extended industry standard architecture (EISA) bus, and the like. The bus 4002 may be classed as an address bus, a data bus, a control bus, and the like. For ease of representation, only one bold line is shown in FIG. 20, but it does not mean that there is only one bus or one type of bus.

The memory 4003 may be read only memory (ROM) or other types of static storage apparatuses that can store static information and instructions, random access memory (RAM) or other types of dynamic storage apparatuses that can store information and instructions, may be electrically erasable programmable read only memory (EEPROM), compact disc read only memory (CD-ROM) or other optical disc storages, an optical disc storage (including a compressed disc, laser disc, optical disc, digital universal disc, Blu-ray disc, or the like), a disk storage medium, other magnetic storage apparatuses, or any other medium that can be used to carry or store computer programs and can be read by a computer, it is not limited herein.

The memory 4003 is used to store computer programs or executable instructions for performing the embodiments of the disclosure, and is controlled for execution by the processor 4001. The processor 4001 is used to execute the computer programs or executable instructions stored in the memory 4003 to implement the steps shown in the preceding method of the embodiments.

An embodiment of the disclosure provides a computer readable storage medium storing computer programs or instructions, the computer programs or instructions, when being executed by at least one processor may perform or implement the steps in the preceding method of the embodiments and corresponding contents.

An embodiment of the disclosure provides a computer program product including computer programs, the computer programs, when being executed by a processor, may implement the steps shown in the preceding method of the embodiments and corresponding contents.

The terms “first”, “second”, “third”, “fourth”, “1”, “2” and the like (if exists) in the specification and claims of the disclosure and the above drawings are used to distinguish similar objects, and need not be used to describe a specific order or sequence. It should be understood that, data used as such may be interchanged in appropriate situations, so that the embodiments of the disclosure described here may be implemented in an order other than the illustration or text description.

It should be understood that, although each operation step is indicated by an arrow in the flowcharts of the embodiments of the disclosure, an implementation order of these steps is not limited to an order indicated by the arrows. Unless explicitly stated herein, in some implementation scenarios of the embodiments of the disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to a requirement, which is not limited by the embodiment of the disclosure.

According to embodiments, a method performed by a network node may comprise obtaining a first channel estimation value of a channel used by a user equipment, by performing frequency-domain channel estimation based on demodulation reference signal (DMRS) symbol decorrelation signal received from the user equipment. The method may comprise determining a channel type of the channel. The method may comprise adjusting frequency offset of the channel and obtaining a second channel estimation value based on the adjusted frequency offset and the first channel estimation value, when the channel type of the channel is a high-speed train channel.

In an embodiment, the obtaining of the first channel estimation value of the channel used by the user equipment, by performing the frequency-domain channel estimation based on demodulation reference signal (DMRS) symbol decorrelation signal received from the user equipment may comprise obtaining a time offset regarding the channel, by performing time offset estimation based on the decorrelation signal. The obtaining of the first channel estimation value of the channel used by the user equipment, by performing the frequency-domain channel estimation based on demodulation reference signal (DMRS) symbol decorrelation signal received from the user equipment may comprise obtaining the first channel estimation value, by performing time offset compensation on the decorrelation signal based on the time offset.

In an embodiment, the determining of the channel type of the channel may comprise determining the channel type of the channel through a neural network, based on the decorrelation signal.

In an embodiment, the neural network may be one of a support vector machine, a convolutional neural network, a recurrent neural network, long short-term memory, a transformer network, or a multilayer perceptron mixer.

In an embodiment, the determining of the channel type of the channel through the neural network, based on the decorrelation signal may comprise obtaining at least one feature of a phase feature, an amplitude feature, a path number feature of the channel, and a signal to noise ratio of the channel, according to the decorrelation signal. The determining of the channel type of the channel through the neural network, based on the decorrelation signal may comprise determining the channel type of the channel through the neural network, based on the at least one feature.

In an embodiment, the obtaining of the at least one feature of the phase feature, the amplitude feature, the path number feature of the channel, and the signal to noise ratio of the channel, according to the decorrelation signal, may comprise determining the signal to noise ratio of the channel according to the decorrelation signal. The obtaining of the at least one feature of the phase feature, the amplitude feature, the path number feature of the channel, and the signal to noise ratio of the channel, according to the decorrelation signal, may comprise obtaining a first signal matching a frequency-domain resource dimension of the neural network by matching a dimension of the decorrelation signal with the frequency-domain resource dimension of the neural network, and extracting at least one of the phase feature and the amplitude feature of the first signal on each resource element or the path number feature of the channel, according to the first signal.

In an embodiment, the determining of the channel type of the channel through the neural network, based on the at least one feature may comprise determining the channel type of the channel through the neural network according to the at least one feature and the first signal.

In an embodiment, the obtaining of the first signal matching the frequency-domain resource dimension of the neural network by matching the dimension of the decorrelation signal with the frequency-domain resource dimension of the neural network, may comprise if the dimension of the decorrelation signal is equal to the frequency-domain resource dimension of the neural network, determining the decorrelation signal as the first signal. The obtaining of the first signal matching the frequency-domain resource dimension of the neural network by matching the dimension of the decorrelation signal with the frequency-domain resource dimension of the neural network, may comprise if the dimension of the decorrelation signal is less than the frequency-domain resource dimension of the neural network, obtaining the first signal, by extending the dimension of the decorrelation signal to the frequency-domain resource dimension of the neural network based on time offset regarding the channel. The obtaining of the first signal matching the frequency-domain resource dimension of the neural network by matching the dimension of the decorrelation signal with the frequency-domain resource dimension of the neural network, may comprise if the dimension of the decorrelation signal is greater than the frequency-domain resource dimension of the neural network, intercepting a portion from the decorrelation signal, based on the frequency-domain resource dimension of the neural network, as the first signal.

In an embodiment, the extracting of the path number feature of the channel, according to the first signal, may comprise determining an amplitude of a time-domain pulse response of the channel according to the first signal. The extracting of the path number feature of the channel, according to the first signal, may comprise extracting the path number feature of the channel according to a count of the amplitudes of the time-domain pulse response that exceeds a predetermined threshold.

In an embodiment, the adjusting of the frequency offset of the channel may comprise determining frequency offset regions that require adjustment in the frequency offset. The adjusting of the frequency offset of the channel may comprise performing frequency offset adjustment in the frequency offset regions.

In an embodiment, the determining of the frequency offset regions that require adjustment in the frequency offset may comprise determining the frequency offset regions that require adjustment in the frequency offset by performing edge detection on the frequency offset.

In an embodiment, the determining of the frequency offset regions that require adjustment in the frequency offset further may comprise performing filtering and/or moving averaging on the frequency offset prior to the edge detection.

In an embodiment, the determining of the frequency offset regions that require adjustment in the frequency offset by performing the edge detection on the frequency offset may comprise calculating slopes of the frequency offset. The determining of the frequency offset regions that require adjustment in the frequency offset by performing the edge detection on the frequency offset may comprise determining positive jumping edges and negative jumping edges of the frequency offset according to the slopes of the frequency offset. The determining of the frequency offset regions that require adjustment in the frequency offset by performing the edge detection on the frequency offset may comprise determining frequency offset between a positive jumping edge and a negative jumping edge which are adjacent, as the frequency offset regions requiring adjustment.

In an embodiment, the performing of the frequency offset adjustment on the frequency offset regions may comprise decreasing frequency offset that is positive in the frequency offset regions by a first predetermined value. The performing of the frequency offset adjustment on the frequency offset regions may comprise increasing frequency offset that is negative in the frequency offset regions by a first predetermined value.

According to embodiments, a network node may comprise a transceiver configured to transmit and receive a signal. The network node may comprise a processor coupled to the transceiver. The processor may be configured to obtain a first channel estimation value of a channel used by a user equipment, by performing frequency-domain channel estimation based on demodulation reference signal (DMRS) symbol decorrelation signal received from the user equipment. The processor may be configured to determine a channel type of the channel. The processor may be configured to adjust frequency offset of the channel and obtaining a second channel estimation value based on the adjusted frequency offset and the first channel estimation value, when the channel type of the channel is a high-speed train channel.

In an embodiment, the processor may be further configured to obtain a time offset regarding the channel, by performing time offset estimation based on the decorrelation signal. The processor may be further configured to obtain the first channel estimation value, by performing time offset compensation on the decorrelation signal based on the time offset.

In an embodiment, the processor may be further configured to determine the channel type of the channel through a neural network, based on the decorrelation signal.

In an embodiment, the neural network may be one of a support vector machine, a convolutional neural network, a recurrent neural network, long short-term memory, a transformer network, or a multilayer perceptron mixer.

According to embodiments, one or more non-transitory computer-readable storage media may store computer-executable instructions that, when executed by one or more processors individually or collectively, cause an electronic device to perform operations. The operations may comprise obtaining a first channel estimation value of a channel used by a user equipment, by performing frequency-domain channel estimation based on demodulation reference signal (DMRS) symbol decorrelation signal received from the user equipment. The operations may comprise determining a channel type of the channel. The operations may comprise adjusting frequency offset of the channel and obtaining a second channel estimation value based on the adjusted frequency offset and the first channel estimation value, when the channel type of the channel is a high-speed train channel.

According to embodiments, a method performed by a network node may comprise obtaining a first channel estimation value of a channel between the network node and a user equipment, by performing frequency-domain channel estimation based on a decorrelation signal related to reference signal symbols received from the user equipment. The method may comprise determining whether a channel type of the channel is a high-speed train channel. The method may comprise in accordance with a determination the channel type of the channel is the high-speed train channel, adjusting frequency offset of the channel, and obtaining a second channel estimation value based on the adjusted frequency offset and the first channel estimation value.

In an embodiment, the obtaining of the first channel estimation value of the channel used by the user equipment, by performing the frequency-domain channel estimation based on the decorrelation signal received related to the reference signal symbols from the user equipment may comprise obtaining a time offset regarding the channel, by performing time offset estimation based on the decorrelation signal. The obtaining of the first channel estimation value of the channel used by the user equipment, by performing the frequency-domain channel estimation based on the decorrelation signal received related to the reference signal symbols from the user equipment may comprise obtaining the first channel estimation value, by performing time offset compensation on the decorrelation signal based on the time offset. The obtaining of the first channel estimation value of the channel used by the user equipment, by performing the frequency-domain channel estimation based on the decorrelation signal received related to the reference signal symbols from the user equipment may comprise wherein the reference signal symbols comprise demodulation reference signal (DMRS) symbols.

In an embodiment, the determining whether the channel type of the channel is the high-speed train channel may comprise determining whether the channel type of the channel is the high-speed train channel based on a neural network, by using the decorrelation signal.

In an embodiment, the neural network comprises at least one of a support vector machine, a convolutional neural network, a recurrent neural network, long short-term memory, a transformer network, or a multilayer perceptron mixer.

In an embodiment, the determining whether the channel type of the channel is the high-speed train channel based on the neural network, by using the decorrelation signal, may comprise obtaining at least one feature of a phase feature, an amplitude feature, a path number feature of the channel, or a signal to noise ratio of the channel, according to the decorrelation signal. The determining whether the channel type of the channel is the high-speed train channel based on the neural network, by using the decorrelation signal, may comprise determining whether the channel type of the channel is the high-speed train channel based on the neural network, by using the at least one feature.

In an embodiment, the obtaining of the at least one feature of the phase feature, the amplitude feature, the path number feature of the channel, or the signal to noise ratio of the channel, according to the decorrelation signal, may comprise determining the signal to noise ratio of the channel according to the decorrelation signal. The obtaining of the at least one feature of the phase feature, the amplitude feature, the path number feature of the channel, or the signal to noise ratio of the channel, according to the decorrelation signal, may comprise obtaining a first signal matching a frequency-domain resource dimension of the neural network by matching a dimension of the decorrelation signal with the frequency-domain resource dimension of the neural network, and extracting at least one of the phase feature, the amplitude feature of the first signal on each resource element, or the path number feature of the channel, according to the first signal.

In an embodiment, the determining whether the channel type of the channel is the high-speed train channel based on the neural network, by using the at least one feature may comprise determining whether the channel type of the channel is the high-speed train channel based on the neural network according to the at least one feature and the first signal.

In an embodiment, the obtaining of the first signal matching the frequency-domain resource dimension of the neural network by matching the dimension of the decorrelation signal with the frequency-domain resource dimension of the neural network, may comprise, in case that the dimension of the decorrelation signal is equal to the frequency-domain resource dimension of the neural network, determining the decorrelation signal as the first signal. The obtaining of the first signal matching the frequency-domain resource dimension of the neural network by matching the dimension of the decorrelation signal with the frequency-domain resource dimension of the neural network, may comprise, in case that the dimension of the decorrelation signal is less than the frequency-domain resource dimension of the neural network, obtaining the first signal, by extending the dimension of the decorrelation signal to the frequency-domain resource dimension of the neural network based on time offset regarding the channel. The obtaining of the first signal matching the frequency-domain resource dimension of the neural network by matching the dimension of the decorrelation signal with the frequency-domain resource dimension of the neural network, may comprise, in case that the dimension of the decorrelation signal is greater than the frequency-domain resource dimension of the neural network, intercepting a portion from the decorrelation signal, based on the frequency-domain resource dimension of the neural network, as the first signal.

In an embodiment, the extracting of the path number feature of the channel, according to the first signal, may comprise determining an amplitude of a time-domain pulse response of the channel according to the first signal. The extracting of the path number feature of the channel, according to the first signal, may comprise extracting the path number feature of the channel according to a count of the amplitudes of the time-domain pulse response that exceeds a predetermined threshold.

In an embodiment, the adjusting of the frequency offset of the channel may comprise determining frequency offset regions that require adjustment in the frequency offset. The adjusting of the frequency offset of the channel may comprise performing frequency offset adjustment in the frequency offset regions.

In an embodiment, the determining of the frequency offset regions that require adjustment in the frequency offset may comprise determining the frequency offset regions that require adjustment in the frequency offset by performing edge detection on the frequency offset.

In an embodiment, the determining of the frequency offset regions that require adjustment in the frequency offset by performing the edge detection on the frequency offset may comprise calculating slopes of the frequency offset. The determining of the frequency offset regions that require adjustment in the frequency offset by performing the edge detection on the frequency offset may comprise determining positive jumping edges and negative jumping edges of the frequency offset according to the slopes of the frequency offset. The determining of the frequency offset regions that require adjustment in the frequency offset by performing the edge detection on the frequency offset may comprise determining a region of the frequency offset between a positive jumping edge and a negative jumping edge which are adjacent, as the frequency offset regions requiring adjustment.

In an embodiment, the performing of the frequency offset adjustment on the frequency offset regions may comprise decreasing frequency offset that is positive in the frequency offset regions by a first predetermined value. The performing of the frequency offset adjustment on the frequency offset regions may comprise increasing frequency offset that is negative in the frequency offset regions by the first predetermined value.

According to embodiments, a network node may comprise memory, including one or more storage media, storing instructions. The network node may comprise at least one processor including processing circuitry. The instructions, when executed by the at least one processor individually or collectively, may cause the network node to obtain a first channel estimation value of a channel between the network node and a user equipment, by performing frequency-domain channel estimation based on a decorrelation signal related to reference signal symbols received from the user equipment. The instructions, when executed by the at least one processor individually or collectively, may cause the network node to determine whether a channel type of the channel is a high-speed train channel. The instructions, when executed by the at least one processor individually or collectively, may cause the network node to in accordance with a determination that the channel type of the channel is the high-speed train channel, adjust frequency offset of the channel, and obtain a second channel estimation value based on the adjusted frequency offset and the first channel estimation value.

In an embodiment, the instructions, when executed by the at least one processor individually or collectively, may cause the network node to obtain a time offset regarding the channel, by performing time offset estimation based on the decorrelation signal. The instructions, when executed by the at least one processor individually or collectively, may cause the network node to obtain the first channel estimation value, by performing time offset compensation on the decorrelation signal based on the time offset. The reference signal symbols may comprise demodulation reference signal (DMRS) symbols.

In an embodiment, the instructions, when executed by the at least one processor individually or collectively, may cause the network node to, determine whether the channel type of the channel is the high-speed train channel based on a neural network, by using the decorrelation signal.

In an embodiment, the neural network may comprise at least one of a support vector machine, a convolutional neural network, a recurrent neural network, long short-term memory, a transformer network, or a multilayer perceptron mixer.

In an embodiment, the instructions, when executed by the at least one processor individually or collectively, may cause the network node to obtain at least one feature of a phase feature, an amplitude feature, a path number feature of the channel, or a signal to noise ratio of the channel, according to the decorrelation signal. The instructions, when executed by the at least one processor individually or collectively, may cause the network node to determine whether the channel type of the channel is the high-speed train channel based on the neural network, by using the at least one feature.

In an embodiment, the instructions, when executed by the at least one processor individually or collectively, may cause the network node to determine the signal to noise ratio of the channel according to the decorrelation signal. The instructions, when executed by the at least one processor individually or collectively, may cause the network node to obtain a first signal matching a frequency-domain resource dimension of the neural network by matching a dimension of the decorrelation signal with the frequency-domain resource dimension of the neural network, and extracting at least one of the phase feature, the amplitude feature of the first signal on each resource element, or the path number feature of the channel, according to the first signal.

According to embodiments, one or more non-transitory computer-readable storage media may store computer-executable instructions that, when executed by one or more processors individually or collectively, cause a network node to perform operations. The operations may comprise obtaining a first channel estimation value of a channel between the network node and a user equipment, by performing frequency-domain channel estimation based on a decorrelation signal related to reference signal symbols received from the user equipment. The operations may comprise determining whether a channel type of the channel is a high-speed train channel. The operations may comprise, in accordance with a determination that the channel type of the channel is the high-speed train channel, adjusting frequency offset of the channel, and obtaining a second channel estimation value based on the adjusted frequency offset and the first channel estimation value.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. A method performed by a network node, the method comprising:
obtaining a first channel estimation value of a channel between the network node and a user equipment, by performing frequency-domain channel estimation based on a decorrelation signal related to reference signal symbols received from the user equipment;
determining whether a channel type of the channel is a high-speed train channel; and
in accordance with a determination the channel type of the channel is the high-speed train channel:
adjusting frequency offset of the channel, and
obtaining a second channel estimation value based on the adjusted frequency offset and the first channel estimation value.

2. The method of claim 1,
wherein the obtaining of the first channel estimation value of the channel used by the user equipment, by performing the frequency-domain channel estimation based on the decorrelation signal received related to the reference signal symbols from the user equipment comprises:
obtaining a time offset regarding the channel, by performing time offset estimation based on the decorrelation signal, and
obtaining the first channel estimation value, by performing time offset compensation on the decorrelation signal based on the time offset, and
wherein the reference signal symbols comprise demodulation reference signal (DMRS) symbols.

3. The method of claim 1, wherein the determining whether the channel type of the channel is the high-speed train channel comprises:
determining whether the channel type of the channel is the high-speed train channel based on a neural network, by using the decorrelation signal.

4. The method of claim 3, wherein the neural network comprises at least one of a support vector machine, a convolutional neural network, a recurrent neural network, long short-term memory, a transformer network, or a multilayer perceptron mixer.

5. The method of claim 3, wherein the determining whether the channel type of the channel is the high-speed train channel based on the neural network, by using the decorrelation signal, comprises:
obtaining at least one feature of a phase feature, an amplitude feature, a path number feature of the channel, or a signal to noise ratio of the channel, according to the decorrelation signal; and
determining whether the channel type of the channel is the high-speed train channel based on the neural network, by using the at least one feature.

6. The method of claim 5, wherein the obtaining of the at least one feature of the phase feature, the amplitude feature, the path number feature of the channel, or the signal to noise ratio of the channel, according to the decorrelation signal, comprises:
determining the signal to noise ratio of the channel according to the decorrelation signal; and/or
obtaining a first signal matching a frequency-domain resource dimension of the neural network by matching a dimension of the decorrelation signal with the frequency-domain resource dimension of the neural network, and extracting at least one of the phase feature, the amplitude feature of the first signal on each resource element, or the path number feature of the channel, according to the first signal.

7. The method of claim 6, wherein the determining whether the channel type of the channel is the high-speed train channel based on the neural network, by using the at least one feature comprises:
determining whether the channel type of the channel is the high-speed train channel based on the neural network according to the at least one feature and the first signal.

8. The method of claim 6, wherein the obtaining of the first signal matching the frequency-domain resource dimension of the neural network by matching the dimension of the decorrelation signal with the frequency-domain resource dimension of the neural network, comprises:
in case that the dimension of the decorrelation signal is equal to the frequency-domain resource dimension of the neural network, determining the decorrelation signal as the first signal;
in case that the dimension of the decorrelation signal is less than the frequency-domain resource dimension of the neural network, obtaining the first signal, by extending the dimension of the decorrelation signal to the frequency-domain resource dimension of the neural network based on time offset regarding the channel; and
in case that the dimension of the decorrelation signal is greater than the frequency-domain resource dimension of the neural network, intercepting a portion from the decorrelation signal, based on the frequency-domain resource dimension of the neural network, as the first signal.

9. The method of claim 6, wherein the extracting of the path number feature of the channel, according to the first signal, comprises:
determining an amplitude of a time-domain pulse response of the channel according to the first signal; and
extracting the path number feature of the channel according to a count of the amplitudes of the time-domain pulse response that exceeds a predetermined threshold.

10. The method of claim 1, wherein the adjusting of the frequency offset of the channel comprises:
determining frequency offset regions that require adjustment in the frequency offset; and
performing frequency offset adjustment in the frequency offset regions.

11. The method of claim 10, wherein the determining of the frequency offset regions that require adjustment in the frequency offset comprises:
determining the frequency offset regions that require adjustment in the frequency offset by performing edge detection on the frequency offset.

12. The method of claim 11, wherein the determining of the frequency offset regions that require adjustment in the frequency offset by performing the edge detection on the frequency offset comprises:
calculating slopes of the frequency offset;
determining positive jumping edges and negative jumping edges of the frequency offset according to the slopes of the frequency offset; and
determining a region of the frequency offset between a positive jumping edge and a negative jumping edge which are adjacent, as the frequency offset regions requiring adjustment.

13. The method of claim 10, wherein the performing of the frequency offset adjustment on the frequency offset regions comprises:
decreasing frequency offset that is positive in the frequency offset regions by a first predetermined value; and/or
increasing frequency offset that is negative in the frequency offset regions by the first predetermined value.

14. A network node comprising:
memory, including one or more storage media, storing instructions; and
at least one processor including processing circuitry,
wherein the instructions, when executed by the at least one processor individually or collectively, cause the network node to:
obtain a first channel estimation value of a channel between the network node and a user equipment, by performing frequency-domain channel estimation based on a decorrelation signal related to reference signal symbols received from the user equipment,
determine whether a channel type of the channel is a high-speed train channel, and
in accordance with a determination that the channel type of the channel is the high-speed train channel:
adjust frequency offset of the channel, and
obtain a second channel estimation value based on the adjusted frequency offset and the first channel estimation value.

15. The network node of claim 14,
wherein the instructions, when executed by the at least one processor individually or collectively, further cause the network node to:
obtain a time offset regarding the channel, by performing time offset estimation based on the decorrelation signal, and
obtain the first channel estimation value, by performing time offset compensation on the decorrelation signal based on the time offset, and
wherein the reference signal symbols comprise demodulation reference signal (DMRS) symbols.

16. The network node of claim 14, wherein the instructions, when executed by the at least one processor individually or collectively, further cause the network node to:
determine whether the channel type of the channel is the high-speed train channel based on a neural network, by using the decorrelation signal.

17. The network node of claim 16, wherein the neural network comprises at least one of a support vector machine, a convolutional neural network, a recurrent neural network, long short-term memory, a transformer network, or a multilayer perceptron mixer.

18. The network node of claim 16, wherein the instructions, when executed by the at least one processor individually or collectively, further cause the network node to:
obtain at least one feature of a phase feature, an amplitude feature, a path number feature of the channel, or a signal to noise ratio of the channel, according to the decorrelation signal; and
determine whether the channel type of the channel is the high-speed train channel based on the neural network, by using the at least one feature.

19. The network node of claim 18, wherein the instructions, when executed by the at least one processor individually or collectively, further cause the network node to:
determine the signal to noise ratio of the channel according to the decorrelation signal; and/or
obtain a first signal matching a frequency-domain resource dimension of the neural network by matching a dimension of the decorrelation signal with the frequency-domain resource dimension of the neural network, and extracting at least one of the phase feature, the amplitude feature of the first signal on each resource element, or the path number feature of the channel, according to the first signal.

20. One or more non-transitory computer-readable storage media storing computer-executable instructions that, when executed by one or more processors individually or collectively, cause a network node to perform operations, the operations comprising:
obtaining a first channel estimation value of a channel between the network node and a user equipment, by performing frequency-domain channel estimation based on a decorrelation signal related to reference signal symbols received from the user equipment;
determining whether a channel type of the channel is a high-speed train channel; and
in accordance with a determination that the channel type of the channel is the high-speed train channel:
adjusting frequency offset of the channel, and
obtaining a second channel estimation value based on the adjusted frequency offset and the first channel estimation value.
